(19) United States
(12) Patent Application Publication
(10) Pub. No.: US 2005/0174429 A1
(43) Pub. Date: Aug. 11, 2005

(54) System for monitoring vehicle surroundings

(75) Inventor: Tatsumi Yanai, Yokohama-shi (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 11/049,352

(22) Filed: Feb. 3, 2005

(30) Foreign Application Priority Data
Feb. 4, 2004 (JP) P2004-28239

(51) Int. Cl. H04N 7/18

(52) U.S. Cl. 348/148; 340/435

(57) ABSTRACT

An aspect of the present invention provides a vehicle surroundings monitoring system that includes, a plurality of cameras configured to photograph regions surrounding a vehicle, a surroundings monitoring control unit configured to determine areas of the images photographed by the cameras to be displayed based on the steering state of the vehicle or an input from a driver and to output image data that combines the images contained in the determined display areas in such a manner that items captured in the displayed images are arranged in positional relationships observed by a driver, and a display configured to display the image data outputted from the surroundings monitoring control unit, wherein the surroundings monitoring control unit is further configured such that it can control the proportion of the display that is occupied by each image displayed on the display.

### BACKGROUND OF THE INVENTION

The present invention is related to a vehicle surroundings monitoring system for checking the conditions surrounding a vehicle with a camera. Japanese Laid-Open Patent Publication No. 2000-238594 proposes a vehicle surroundings monitoring device configured to display images photographed with a plurality of cameras on a single display, the cameras being arranged and configured to photograph the area surrounding a vehicle in which the vehicle surroundings monitoring device is installed.

### SUMMARY OF THE INVENTION

With the conventional device just described, however, the images obtained with the plurality of cameras are divided in a fixed manner on the display screen and the displayed surface area of each individual camera image on the screen is sometimes too small. Furthermore, since the individual camera images are merely arranged on the screen, it is difficult to gain an intuitive feel for the situation surrounding the vehicle from the camera images.

The present invention was conceived to solve these problems by providing a vehicle surroundings monitoring system that can detect which camera images are need by the driver based on the steering state of the vehicle and change the way the images are presented on the display so that the relationships between the images are easier for the driver to understand.

An aspect of the present invention provides a vehicle surroundings monitoring system that includes, a plurality of cameras configured to photograph regions surrounding a vehicle, a surroundings monitoring control unit configured to determine areas of the images photographed by the cameras to be displayed based on the steering state of the vehicle or an input from a driver and to output image data that combines the images contained in the determined display areas in such a manner that items captured in the displayed images are arranged in positional relationships observed by a driver, and a display configured to display the image data outputted from the surroundings monitoring control unit, wherein the surroundings monitoring control unit is further configured such that it can control the proportion of the display that is occupied by each image displayed on the display.

Another aspect of the present invention provides a method of monitoring the surroundings of a vehicle that includes photographing a plurality of images of regions surrounding the vehicle, determining areas of the photographed images to be displayed on a display based on the steering state of the vehicle or an input from a driver and combining the images contained in the determined display areas to display in such a manner that the positional relationships between items captured in the displayed images are to be the positional relationships observed by a driver, wherein the proportion of the display that is occupied by each image displayed on the display is controlled.

### BRIEF DESCRIPTION OF THE DRAWINGS

FIG. 1 is a block diagram showing the constituent features of a first embodiment of the vehicle surroundings monitoring system.

FIG. 2 illustrates an example of how a vehicle surroundings monitoring system in accordance with this embodiment might be installed in a vehicle.

FIGS. 3A to 3C show an example of displaying a two-image screen on the display 103 (two-image display mode).

FIGS. 4A to 4C illustrate a stage in which the driver continues to back the vehicle with the steering wheel turned to the left but the steering angle is reduced and the vehicle is about to advance into the parking space.

FIGS. 5A to 5C illustrate a stage in which the driver returns the steering angle approximately to the center and is backing the vehicle into the parking space.

FIGS. 6A to 6D show an example of displaying a three-image screen on the display 103 (three-image display mode).

FIGS. 7A to 7D illustrate a stage in which the driver continues to back the vehicle with the steering wheel turned to the left but the steering angle is reduced and the vehicle is about to advance into the parking space.

FIGS. 8A to 8D illustrate a stage in which the driver returns the steering angle approximately to the center and is backing the vehicle into the parking space.

FIG. 9 is a flowchart illustrating the overall flow of the steps executed in order to control the switching of the image display.

FIG. 10 is a flowchart for explaining step S107 of FIG. 9 in detail.

FIG. 11 is a flowchart for explaining step S204 of FIG. 9 in detail.

FIG. 12 is a block diagram of a vehicle surroundings monitoring system in accordance with the second embodiment.

FIGS. 13A to 13D illustrates the three-image screen (1) of combined image obtained with the second embodiment.

FIG. 14A to 14E illustrate the three-image screen (3) of combined image obtained with the second embodiment.

FIG. 15 is a flowchart for explaining step S107 of FIG. 9 in detail.

FIG. 16 is a block diagram of a vehicle surroundings monitoring system in accordance with the third embodiment.

FIG. 17 shows the arrangement of the constituent components of this embodiment.

FIG. 18 illustrates how this embodiment functions when the vehicle 131′ is traveling very slowly or is stopped before an intersection where visibility is poor.

FIG. 19A to 19E show an example of how the images of the three front cameras are combined onto a single screen and displayed on the display 103 when the advancement distance L is equal to or larger than 0 and less than a prescribed distance L1.

FIG. 20A to 20D show an example of how the images of the three front cameras are combined onto a single screen and displayed on the display 103 when the advancement distance L is equal to or larger than a prescribed distance L2.

FIG. 21 is a flowchart illustrating the overall flow of the steps executed in order to control the switching of the image display.

### DETAILED DESCRIPTION OF THE EMBODIMENTS

Various embodiments of the present invention will be described with reference to the accompanying drawings. It is to be noted that same or similar reference numerals are applied to the same or similar parts and elements throughout the drawings, and the description of the same or similar parts and elements will be omitted or simplified.

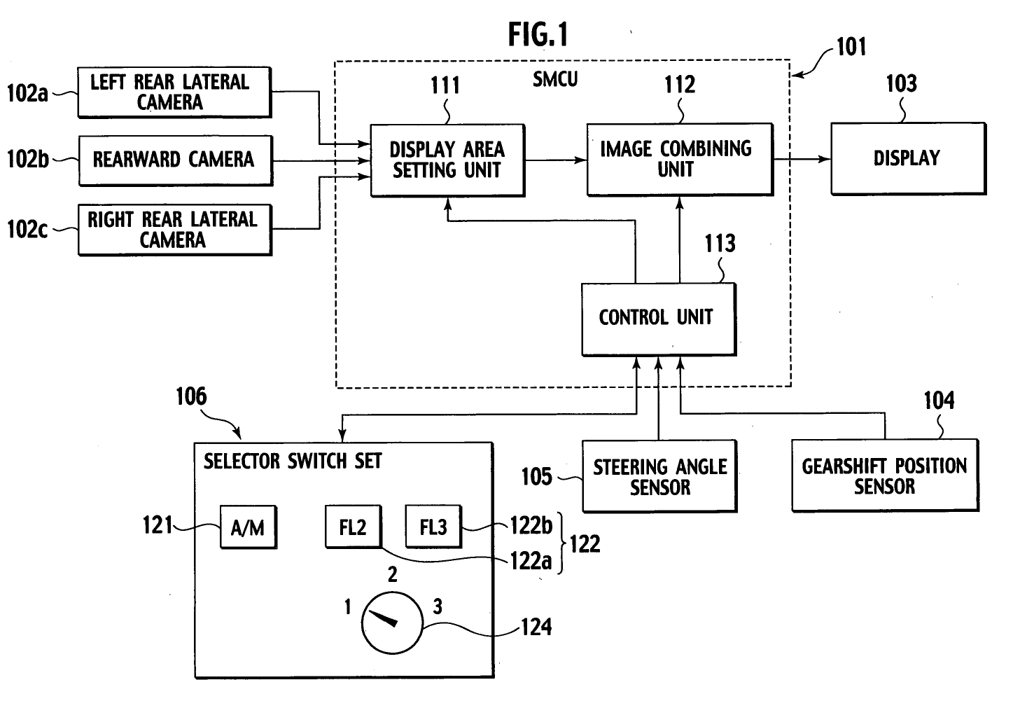

FIG. 1 is a block diagram showing the constituent features of a first embodiment of the vehicle surroundings monitoring system. This embodiment is provided with a left rear lateral camera 102a on a rearward part of the left side of the vehicle, a rearward camera 102b on a rear part of the vehicle, and a right rear lateral camera 102c on a rearward part of the right side of the vehicle. The cameras 102a, 102b, 102c are connected to a surroundings monitoring control unit (SMCU) 101 and the images they photograph are fed to the surroundings monitoring control unit 101. The SMCU 101 executes an image processing (described later) and displays the image resulting from the image processing on a display 103 installed in the vehicle.

The SMCU 101 is connected to a selector switch set 106 that enables the driver to change the method of displaying the camera images on the display 103 and a gearshift position sensor 104 that detects if the vehcle is in reverse and a steering angle sensor 105 that detects the steering angle. The SMCU 101 comprises the following: a display area setting unit 111 configured to acquire camera images from the three cameras 102a, 102b, 102c and exsect an area of each camera image to be displayed on the display 103; an image combining unit 112 configured to combine the display areas exsected from the camera images in a prescribed arrangement on a single screen; a control unit (controller) 113 configured to issue commands to the display area setting unit 111 specifying the display areas to be exsected from the camera images and commands to the image combining unit 112 specifying which method to use for arranging the display areas, the commands being based on signals from the steering angle sensor 105 and the selector switch set 106.

The selector switch set 106 has an Auto/Manual selector switch (hereinafter called “A/M switch”) 121 that enables selection of an Auto mode or a Manual mode in which the method of displaying the surroundings monitoring images on the display 103 is set in an automatic manner or a manual manner, respectively, a two-image selection switch (FL2) 122a for selectively displaying either the images photographed by the left rear lateral camera 102a and the rearward camera 102b or the images photographed by the rearward camera 102b and the right rear lateral camera 102c on the display 103; and a three-image selection switch (FL3) 122b for displaying the images photographed by all three cameras 102a, 102b, 102c on the display 103. Hereinafter, the two-image selection switch 122a and the three-image selection switch 122b are referred to collectively as the “image count selector switch 122.” The A/M switch 121, the two-image selection switch 122a, and the three-image selection switch 122b are, for example, push button switches provided with a colored lamp in the button section that illuminates when the switch is on.

The selector switch set 106 is also provided with a display area selector switch 124 that enables the display area of each camera image to be set manually when two-image or three-image mode is selected. The display area selector switch 124 is, for example, a rotary switch that can be set to any one of positions 1, 2, and 3. The ON signals from these switches are fed to the controller 113.

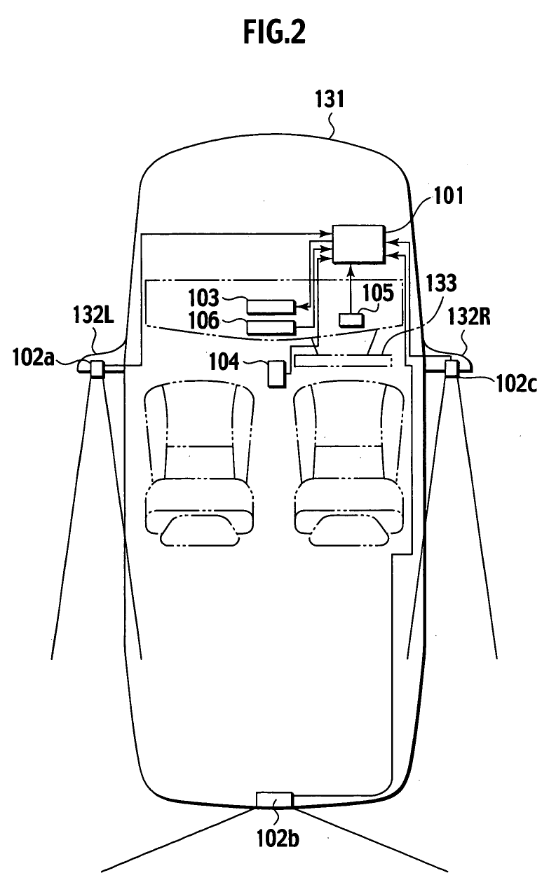

FIG. 2 illustrates an example of how a vehicle surroundings monitoring system in accordance with this embodiment might be installed in a vehicle. The display 103 is, for example, a liquid crystal display provided in a front part of the vehicle cabin in a position that is easily viewed by the driver, e.g., on the instrument panel. The selector switch set 106 is arranged near the display 103. The gearshift position sensor 104 is provided in the gearshift mechanism (not shown) installed in the floor of a front part of the cabin and the steering angle sensor 105 is provided in the steering column of the steering wheel 133.

Rear camera 102b is mounted to a rear part of the vehicle 131 at a position located approximately midway in the vertical direction and approximately in the center in the transverse direction of the vehicle. The rear camera 102b is tilted downward so that it can photograph the surface of the ground behind the vehicle 131. The left rearward lateral camera 102a and the right rearward lateral camera 102c are installed on the left and right door mirrors 132L, 132R of the vehicle 131 and are oriented to face rearward such that they can photograph the regions behind the left and right side sections of the vehicle 131. The left and right rearward lateral cameras 102a, 102c are installed in such a manner that the photographing directions thereof are not affected when the driver adjusts the reflective surfaces of the door mirrors 132L, 132R to meet his or her needs. For example, the left and right rearward lateral cameras 102a and 102c can be configured such that they operate independently of the reflective surfaces of the door mirrors 132L, 132R.

The operation of the selector switch 106 and the functions of the controller 113 will now be described. The vehicle surroundings monitoring system is interlocked with the ignition key switch (not shown in the figures) such that it enters a waiting mode when the ignition key switch is turned on. The vehicle surroundings monitoring system starts operating when the gearshift position sensor 104 detects that the gearshift is in the reverse position and, after having started operating, stops operating either when a prescribed amount of time has elapsed with the gearshift position sensor 104 detecting a position other than the reverse position or when the ignition key switch is turned off.

When the vehicle surroundings monitoring system starts operating, the first action taken by the controller 113 is to automatically set the system to Auto mode. When the system is in Auto mode, the controller 113 illuminates, for example, a green lamp in the button section of the A/M switch 121. If the driver presses the A/M switch 121, the controller 113 switches the system to Manual mode, turns off the green lamp, and illuminates, for example, a red lamp in the button section of the A/M switch 121.

When the system is in Auto mode, the controller 113 initially sets the system to the three-image display mode to display the images photographed by all three cameras and illuminates, for example, a green lamp in the button section of the three-image selection switch 122b. From this state, if the driver presses the two-image selection switch 122a, the controller 113 sets the system to the two-image display mode that displays the two camera images corresponding to the steering direction detected by the steering angle sensor 105, turns off the lamp in the button section of the three-image selection switch 122b, and illuminates a green lamp in the button section of the two-image selection switch 122a. Then, if the driver presses the three-image selection switch 122b, the controller 113 turns off the lamp in the button section of the two-image selection switch 122a, illuminates the green lamp in the button section of the three-image selection switch 122b, and returns to three-image display mode.

The controller 113 selects which of the three camera images will be used on the display based on the driver's selection of either the two-image display mode or the three-image display mode. When two-image display mode is selected, the controller 113 automatically controls the selection of either a combination of the camera images of the left rearward lateral camera 102a and the rear camera 102b or a combination of the camera images of the right rearward lateral camera 102c and the rear camera 102b, the selection being based on the steering angle signal from the steering angle sensor 105. Furthermore, the controller 113 sets the display areas to be exsected from the selected camera images for display on the display 103 in accordance with the steering angle and commands the display area setting unit 111 to exsect those display areas. The setting of the display areas exsected from the camera images can be changed in, for example, three patterns. The controller 113 sets the display areas by selecting from among two or three preset display area patterns in which the relative sizes of display areas are different. The controller 113 also issues a command to the image combining unit 112 specifying the method of arranging the exsected display areas on the two-image or three-image display.

When the system is in Manual mode, the controller 113 initially sets the system to the three-image display mode and illuminates the green lamp in the button section of the three-image selection switch 122b. If the driver turns the image selector switch 122a on, the controller 113 receives the image count selection signal in the same manner as in Auto mode and switches to the two-image display mode. When the two-image display mode is selected, the controller 113 automatically controls the selection of either a combination of the camera images of the left rearward lateral camera 102a and the rear camera 102b or a combination of the camera images of the right rearward lateral camera 102c and the rear camera 102b, the selection being based on the steering angle signal from the steering angle sensor 105. Additionally, the controller 113 sets the display areas to be exsected from the selected camera images for display on the display 103 in accordance with the position (position 1, 2, or 3) of the display area selector switch 124 set by the driver and commands the display area setting unit 111 to exsect those display areas. The setting of the display areas exsected from the camera images can be changed in, for example, three patterns. The controller 113 also issues a command to the image combining unit 112 specifying the method of arranging the exsected display areas on the two-image or three-image display.

The display area setting unit 111 and image combining unit 112 of this embodiment can be realized with a single image processor and an image memory. The controller 113 can be realized with, for example, a CPU (central processing unit), a ROM, and a RAM. The image processor is connected to and controlled by the CPU and an image output signal from the image processor is fed to the display 103. The camera images displayed on the display 103 are arranged in such a fashion that the horizontal and vertical relationships between the images are the same as when the rearview mirror and door mirrors are used by the driver to look in the rearward direction. Consequently, all of the camera images presented in the explanations below are displayed with the left and right sides inverted in the manner of a mirror image.

The relationships between the camera images and the images displayed on the display 103 will now be explained using a concrete example. In this example, the driver is attempting to park the vehicle in a parking space demarcated with white lines in a parking lot by backing into the parking space from a parking lot aisle oriented at a right angle with respect to the parking space with the steering wheel turned to the left.

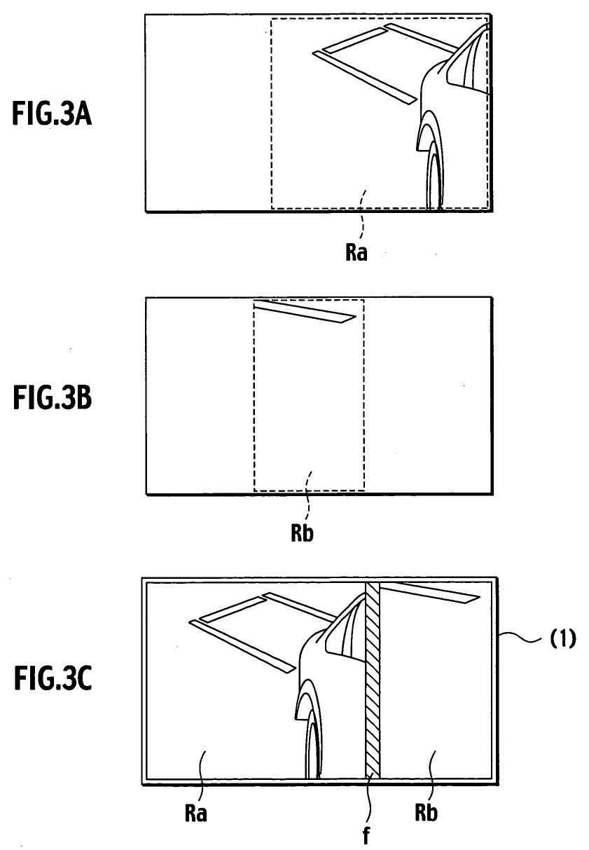

FIGS. 3A to 3C show an example of displaying a two-image screen on the display 103 (two-image display mode). These figures illustrate a stage in which the steering wheel is turned sharply to the left and the vehicle is approaching the parking space. The images of the left rearward lateral camera 102a and the rear camera 102b are selected and the display areas exsected from the two camera images are displayed on one screen.

FIG. 3A shows the camera image obtained with the left rearward lateral camera 102a, FIG. 3B shows the camera image obtained with the rear camera 102b, and the areas enclosed in the broken-line frames in FIGS. 3A and 3B are the display areas Ra, Rb that will be exsected from the camera images by the display area setting unit 111. This example illustrates a case in which the display area Ra is set to be wider from left to right than the display area Rb. FIG. 3C shows the result obtained when the display areas Ra, Rb are arranged side by side on a single screen and the boundary region f there-between (indicated with cross hatching in the figure) is treated with a gap processing, such as being colored in black. Hereinafter, the combined image shown in FIG. 3C will be called the “two-image screen (1).”

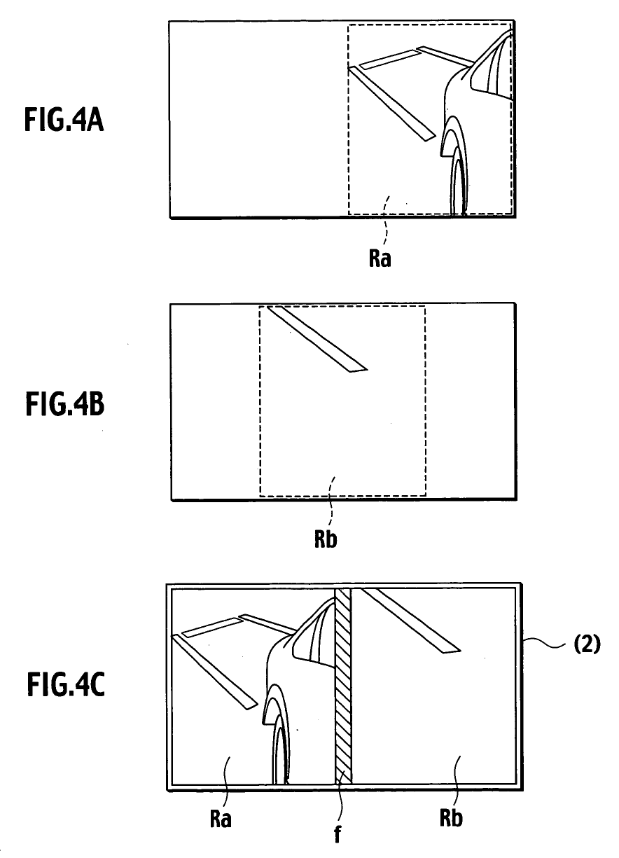

FIGS. 4A to 4C illustrate a stage in which the driver continues to back the vehicle with the steering wheel turned to the left but the steering angle is reduced and the vehicle is about to advance into the parking space. FIG. 4A shows the camera image obtained with the left rearward lateral camera 102a and FIG. 4B shows the camera image obtained with the rear camera 102b. Hereinafter, the combined image shown in FIG. 4C will be called the “two-image screen (2).” The difference with respect to the images of FIG. 3 is that the left-to-right widths of the display areas Ra and Rb are approximately the same.

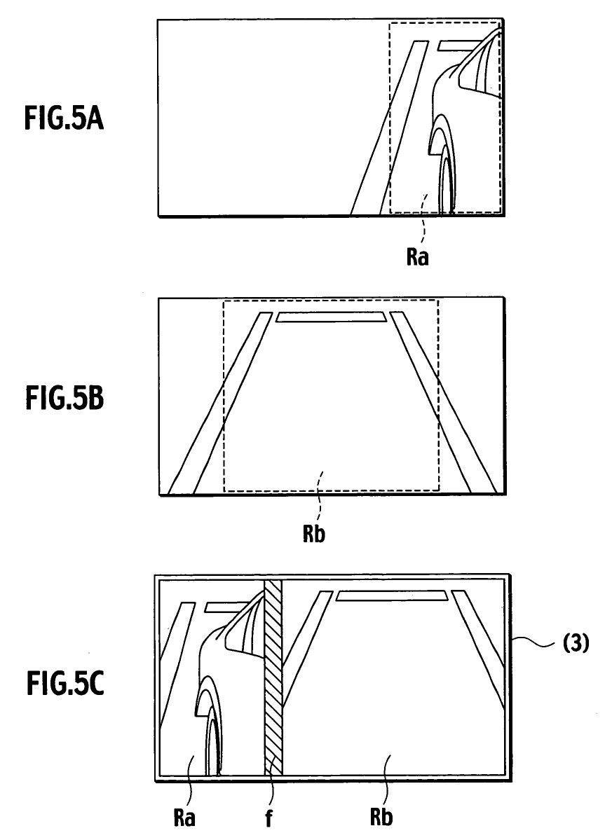

FIGS. 5A to 5C illustrate a stage in which the driver returns the steering angle approximately to the center and is backing the vehicle into the parking space. FIG. 5A shows the camera image obtained with the left rearward lateral camera 102a and FIG. 5B shows the camera image obtained with the rear camera 102b. The combined image shown in FIG. 5C is called the “two-image screen (3).” The difference with respect to the images of FIG. 3 and FIG. 4 is that the left-to-right width of the display area Ra and is smaller than that of the display area Rb. The display of a two-image screen in a case in which the steering wheel is turned to the right will now be described. The difference with respect to the case of leftward steering illustrated in FIGS. 3 to 5 is that the display area Rb exsected from the image obtained with the rear camera 102b is arranged on the left side of the screen and the display area Rc exsected from the image obtained with the right rearward lateral camera 102c is arranged on the right side of the screen.

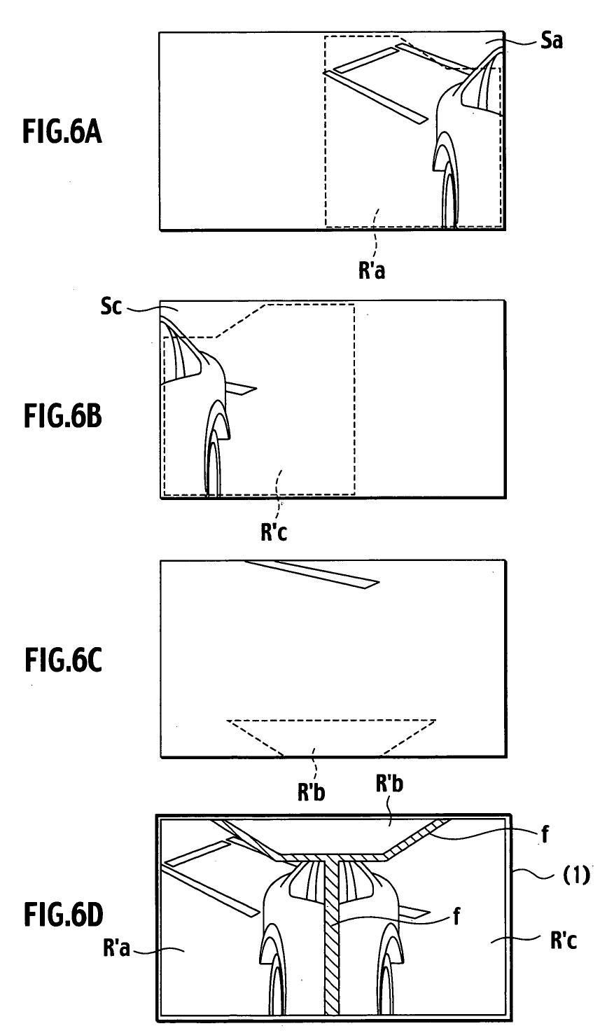

FIGS. 6A to 6D show an example of displaying a three-image screen on the display 103 (three-image display mode). Similarly to FIGS. 3 to 5, FIGS. 6 to 8 illustrate an example of combining the camera images of the left rearward lateral camera 102a, the rear camera 102b, and the right rearward lateral camera 102c onto one screen at stages from when the vehicle is approaching a parking space in reverse with the steering wheel turned to the left until when the vehicle is entering the parking space. FIGS. 6A to 6D illustrate a stage in which the steering wheel is turned sharply to the left and the vehicle is approaching the parking space. FIG. 6A shows the camera image obtained with the left rearward lateral camera 102a, FIG. 6B shows the camera image obtained with the right rearward lateral camera 102c, and FIG. 6C shows the camera image obtained with the rear camera 102b. The areas enclosed in the broken-line frames in FIGS. 6A to 6C are the display areas R′a, R′c, R′b that will be exsected from the camera images by the display area setting unit 111. The display areas R′a and R′c are left-right symmetrical and cover the entire vertical dimension of the camera images except for trapezoidal cutaway sections Sa, Sc provided on upper rearward portions near the vehicle body. In the left-to-right widthwise direction of the camera images, the display areas R′a and R′c cover approximately half the width of the camera image on the side near the vehicle body. In the rear camera image shown in FIG. 6c, the display area R′b is located toward the rear of the vehicle body and has the shape of an upside-down isosceles trapezoid. The height (length in the longitudinal direction of the vehicle) and the horizontal width of the isosceles trapezoid are set to be small. The combined image shown in FIG. 6D is called the “three-image screen (1).” FIG. 6D shows the result obtained when the display areas are combined on a single screen such that the display areas R′a and R′c are arranged side by side, the display area R′b is arranged in an intermediate position there-above, and the boundary region f there-between is treated with a gap processing.

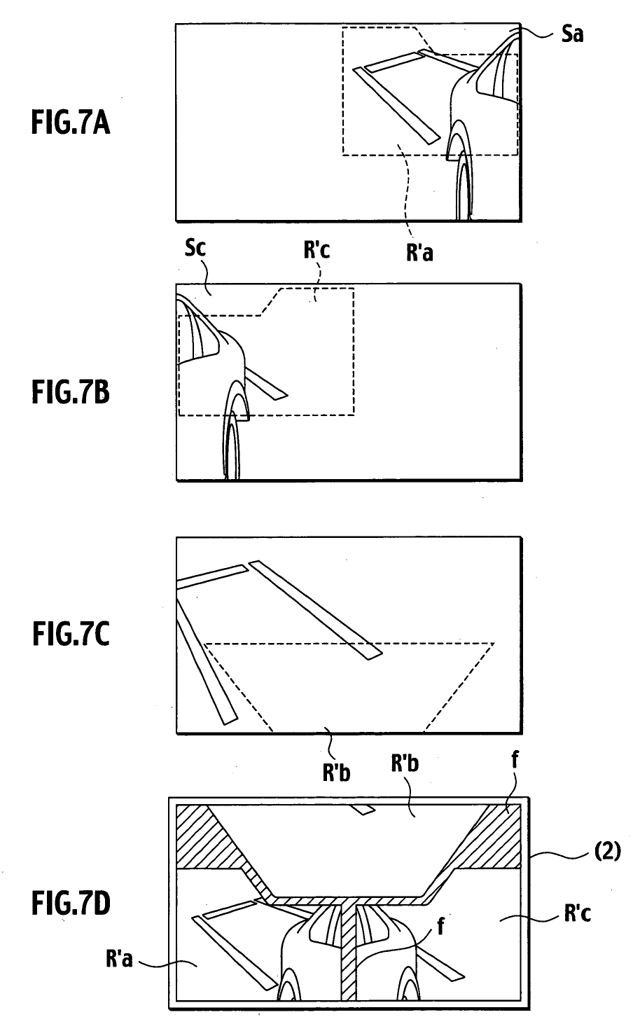

FIGS. 7A to 7D illustrate a stage in which the driver continues to back the vehicle with the steering wheel turned to the left but the steering angle is reduced and the vehicle is about to advance into the parking space. FIG. 7A shows the camera image obtained with the left rearward lateral camera 102a, FIG. 7B shows the camera image obtained with the right rearward lateral camera 102c, and FIG. 7C shows the camera image obtained with the rear camera 102b. The combined image shown in FIG. 7D is called the “three-image screen (2).” The difference with respect to FIG. 6, is that in FIG. 7 the display areas R′a and R′c cover approximately the upper two-thirds of the vertical dimension of the respective camera images, the horizontal widths of the trapezoidal cutaway sections Sa and Sc are larger, and the angles of the diagonal sides of the trapezoidal cutaway sections Sa and Sc are closer to vertical. The height of the display area R′b is set to approximately one-half of the vertical dimension of the camera image and the angle of the diagonal sides thereof is closer to vertical.

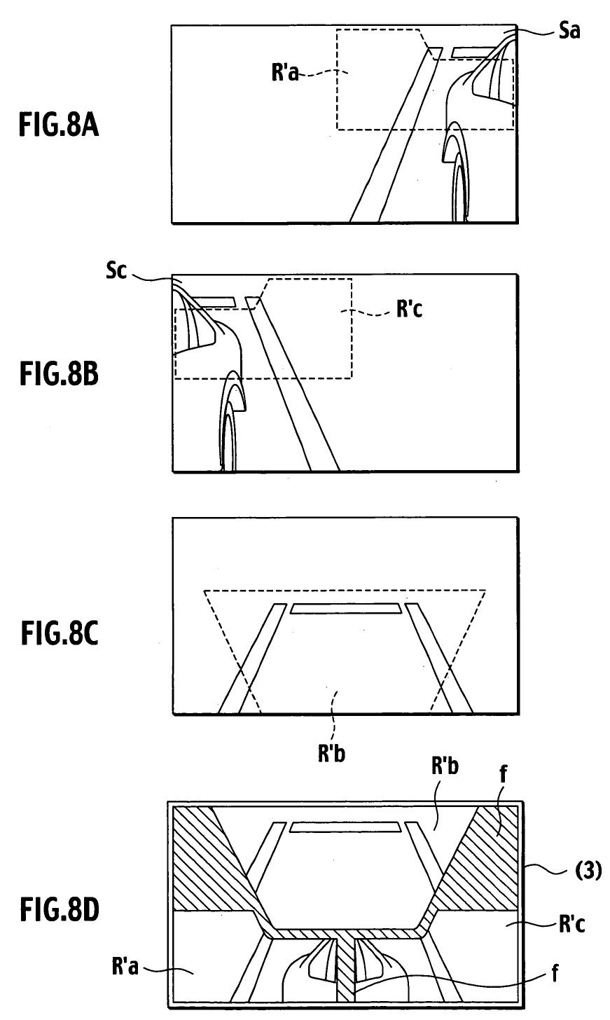

FIGS. 8A to 8D illustrate a stage in which the driver returns the steering angle approximately to the center and is backing the vehicle into the parking space. FIG. 8A shows the camera image obtained with the left rearward lateral camera 102a, FIG. 8B shows the camera image obtained with the right rearward lateral camera 102c, and FIG. 8C shows the camera image obtained with the rear camera 102b. The combined image shown in FIG. 8D is called the “three-image screen (3).” The difference with respect to FIGS. 6 and 7, is that in FIG. 8 the display areas R′a and R′c cover approximately the upper one-half of the vertical dimension of the respective camera images, the horizontal widths of the trapezoidal cutaway sections Sa and Sc are even larger, and the angles of the diagonal sides of the trapezoidal cutaway sections Sa and Sc are even closer to vertical. The height of the display area R′b is set to approximately two-thirds of the vertical dimension of the camera image and the angle of the diagonal sides thereof is even closer to vertical.

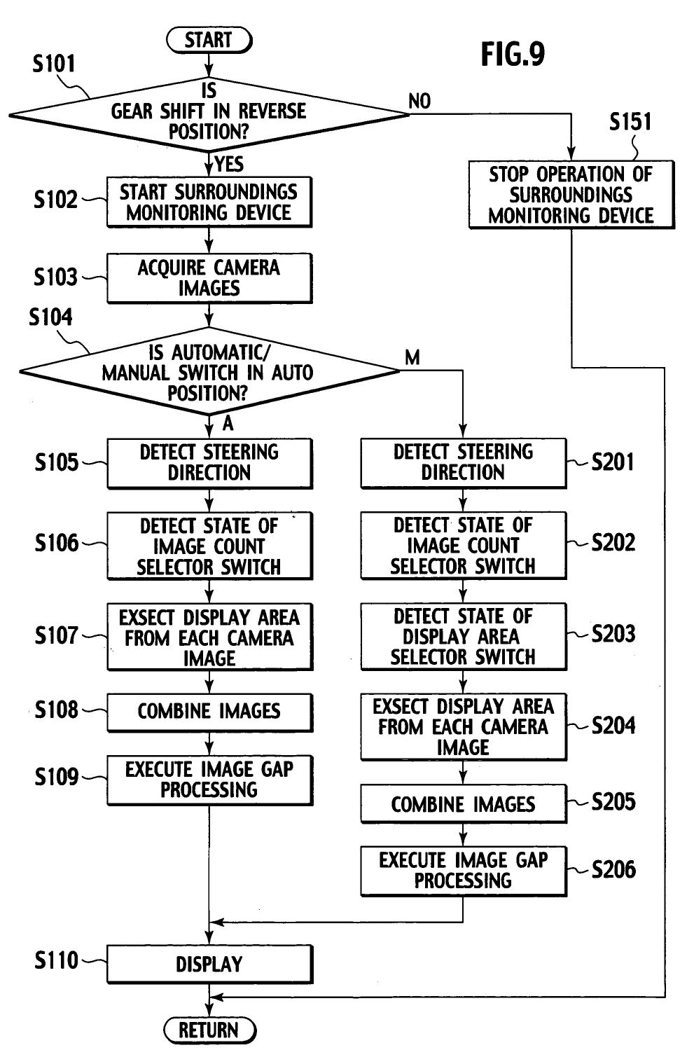

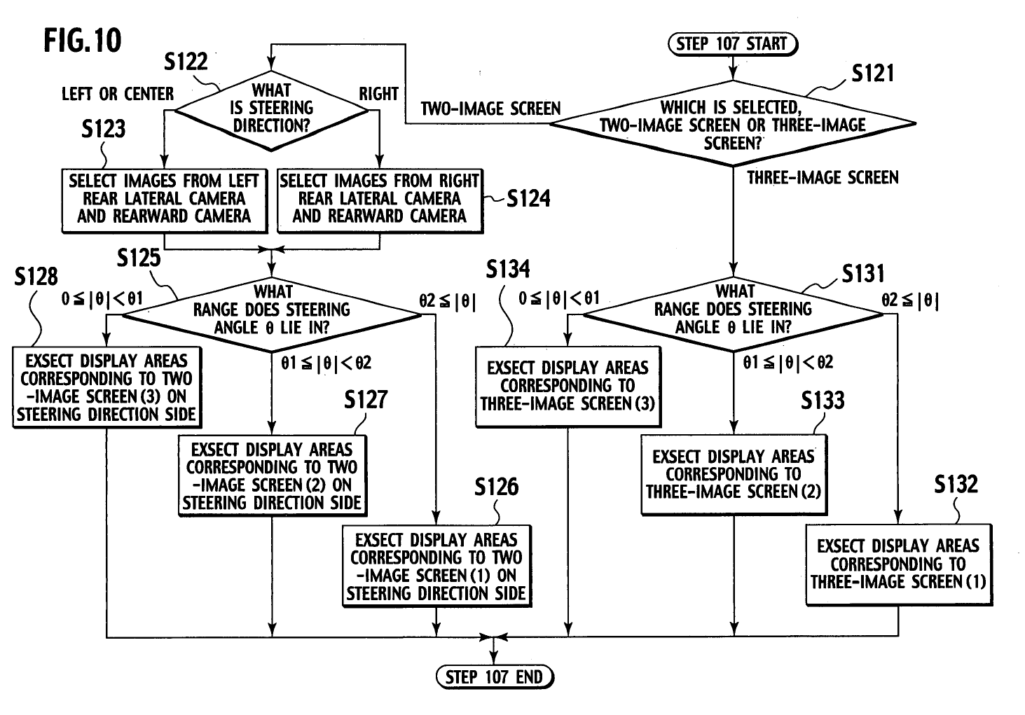

FIG. 9 is a flowchart illustrating the overall flow of the steps executed in order to control the switching of the image display. The flow of the image display switching control executed by this embodiment will now be described. When the ignition key (omitted from figures) is turned on, the vehicle surroundings monitoring system enters a waiting mode. The control routine shown in the flowchart is processed as a program executed by the controller 113, the display area setting unit 111, and the image combining unit 112. In steps S101, the controller 113 checks if the gearshift is in the reverse position based on the signal from the gearshift position sensor 104. If the gearshift is in the reverse position, the controller 113 proceeds to step S102. If the gearshift is not in the reverse position, the controller 113 proceeds to step S151, where, if the vehicle surroundings monitoring system is operating, the controller 113 determines if the gearshift has been in a position other than the reverse position for a prescribed amount of time. If so, the operation of the vehicle surroundings monitoring system is stopped. If not, the controller 113 returns to step S101. In step S102, the controller 113 starts the vehicle surroundings monitoring system if the system is not already operating. In this embodiment, after turning on the left rearward lateral camera 102a, the rear camera 102b, the right rearward lateral camera 102c, and the display 103, the controller 113 automatically sets the selector switch set 106 to the Auto mode and selects the three-image display mode. In step S103, the display area setting unit 111 acquires camera images from the left rearward lateral camera 102a, the rear camera 102b, and the right rearward lateral camera 102c. In step S104, the controller 113 determines whether the AIM switch 121 is set to Auto or Manual. If the A/M switch 121 is in Auto mode, the controller 113 proceeds to step S105. If it is in Manual mode, the controller 113 proceeds to step S201. In step S105, the controller 113 detects the steering direction based on the signal from the steering angle sensor 105. In step S106, the controller 113 detects the state of the image count selector switch 122, i.e., if the two-image selection switch 122a is on or the three image selection switch 122b is on. In step S107, the controller 113 sets the display areas to be exsected from the camera images based on the steering angle and the status of the image count selector switch 122 and sends the set display areas to the display area setting unit 111. The display area setting unit 111 then exsects the display areas and sends the exsected display areas to the image combining unit 112. The details of the control executed in step S107 will be explained later based on FIG. 10. In step S108, the image combining unit 112 combines the display areas exsected in step S107 on to a single screen. Then, in step S109, gap processing is executed to blacken in the gaps between the pasted images. After step S109, control proceeds to step S110 and the display 103 presents the combined image to the driver.

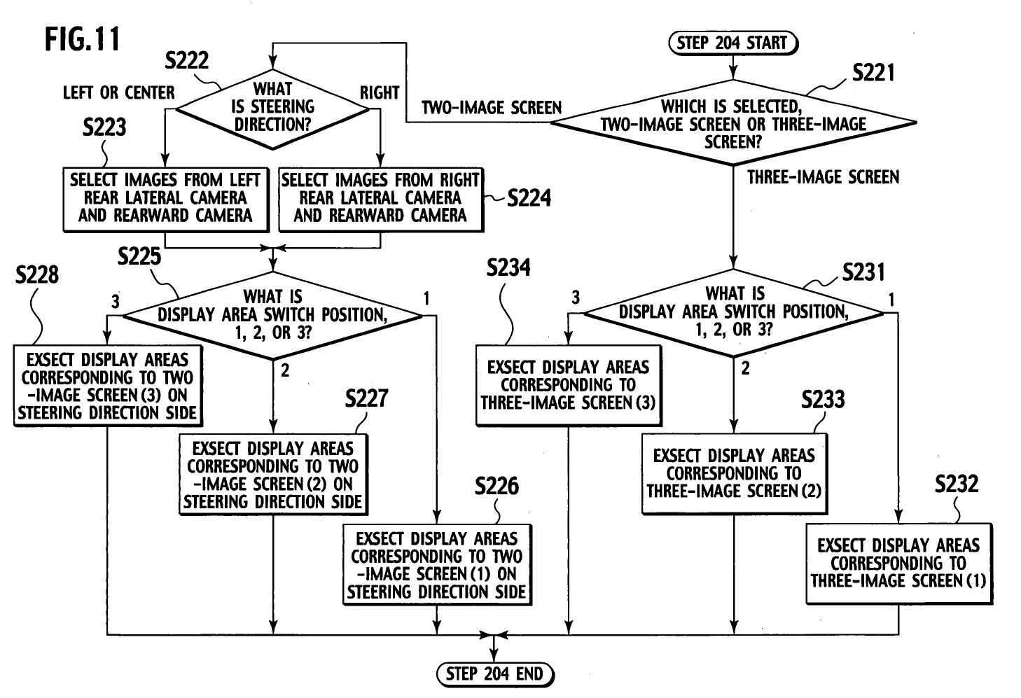

If the AIM switch is found to be set to A/M mode in step S104, the controller 113 proceeds to step S201 where it detects the steering direction based on the signal from the steering angle 105. In step S202, the controller 113 detects the setting status of the image count selector switch 122. In step S203, the controller 113 detects the setting status of the display range selector switch 124. In step S204, the controller 113 sets the display areas to be exsected from the camera images based on the steering angle, the status of the image count selector switch 122, and the setting status of the display range selector switch 124 and sends the set display areas to the display area setting unit 111. The display area setting unit 111 exsects the display areas and sends the exsected display areas to the image combining unit 112. The details of the control executed in step S204 will be explained later based on FIG. 11. In step S205, the image combining unit 112 combines the display areas exsected in step S204 on to a single screen. Then, in step S206, gap processing is executed to blacken in the gaps between the pasted images. After step S206, control proceeds to step S110 and the display 103 presents the combined image to the driver. After step S110, control returns to step S101.

FIG. 10 is a flowchart for explaining step S107 of FIG. 9 in detail. After step S106, the controller 113 proceeds to step S121 and checks whether the driver has selected the two-image display mode or the three-image display mode based on the results of step S106, in which the status of the image count selector switch 122 is detected. If the two-image selection switch 122a is on, the controller 113 proceeds to step S122. If the three-image selection switch 122b is on, the controller 113 proceeds to step S131. In step S122, the controller 113 checks if the steering direction is to the left or to the right. The steering angle 109 is defined to have a positive value when the steering direction is to the left, a value of 0 when the steering direction is in the center, and a negative value when the steering direction is to the right. If the steering direction is to the left or in the center, the controller 113 proceeds to step S123 and selects the camera images of the left rearward lateral camera 102a and the rear camera 102b as the camera images to display on the display 103. If the steering direction is to the right, the controller 113 proceeds to step S124 and selects the camera images of the right rearward lateral camera 102c and the rear camera 102b as the camera images to display on the display 103. After step S123 or S124, the controller 113 proceeds to step S125. In step S125, the controller 113 checks the range in which the absolute value |θ| of the steering angle θ lies. If the absolute value |θ| of the steering angle is equal to or larger than a prescribed value θ2, the controller 113 proceeds to step S126 and sets the display regions to be exsected in order to display the two-image screen (1) for the side corresponding to the steering direction. The controller 113 then sends a command to the display area setting unit 111 instructing it to exsect the display areas and a command to the image combining unit 112 instructing which arrangement method to use. The display area setting unit 111 receives the command, exsects the specified display areas from the specified camera images, and sends the exsected display areas to the image combining unit 112. For example, if the steering direction is to the left, the display area setting unit 111 exsects display areas like the display areas Ra, Rb indicated with broken-line frames in FIGS. 3A and 3B and sends the display areas Ra, Rb to the image combining unit 112.

If the absolute value |θ| of the steering angle is equal to or larger than a prescribed value θ1 and less than the prescribed value θ2, the controller 113 proceeds to step S127 and sets the display regions to be exsected in order to display the two-image screen (2) for the side corresponding to the steering direction. The controller 113 then sends a command to the display area setting unit 111 instructing it to exsect the display areas and a command to the image combining unit 112 instructing which arrangement method to use. The display area setting unit 111 receives the command, exsects the specified display areas from the specified camera images, and sends the exsected display areas to the image combining unit 112. For example, if the steering direction is to the left, the display area setting unit 111 exsects display areas like the display areas Ra, Rb indicated with broken-line frames in FIGS. 4A and 4B and sends the display areas Ra, Rb to the image combining unit 112. If the absolute value |θ| of the steering angle is equal to or larger than 0 but less than the prescribed value θ1, the controller 113 proceeds to step S128 and sets the display regions to be exsected in order to display the two-image screen (3) for the side corresponding to the steering direction. The controller 113 then sends a command to the display area setting unit 111 instructing it to exsect the display areas and a command to the image combining unit 112 instructing which arrangement method to use. The display area setting unit 111 receives the command, exsects the specified display areas from the specified camera images, and sends the exsected display areas to the image combining unit 112. For example, if the steering direction is to the left, the display area setting unit 111 exsects display areas like the display areas Ra, Rb indicated with broken-line frames in FIGS. 5A and 5B and sends the display areas Ra, Rb to the image combining unit 112. After steps S126, S127, and S128, control proceeds to step S108.

Steps S122 to S128 serve to automatically change the display areas of the camera images used in the two-image screens in accordance with the changes in the steering state of the vehicle. For example, when the vehicle moves from a stage in which it is approaching a parking space with a large steering angle to a stage in which it is moving in reverse within the parking space with a small steering angle, these steps serve to change the display state in the manner explained regarding FIGS. 3A to 3C, FIGS. 4A to 4C, and FIGS. 5A to 5C. In the stage of approaching the parking space, the rearward lateral camera on the side corresponding to the steering direction is needed to grasp the position of the parking space. In the case of leftward steering as in the example presented in said figures, the display area of the camera image of the left rearward lateral camera 102a is set automatically to be large and extend outward in the leftward direction and the display area of the camera image of the rear camera 102b is set to be small. In the stage of backing within the parking space, a display area providing rearward depth across the entire width of the vehicle needs to be exsected from the rear camera image in order to determine if there are obstacles in the way and check the distance to the wheel stop or rear parking space line. Thus, as shown the example presented in said figures, the display area of the camera image of the rear camera 102b is set automatically to be wide from left to right and the display area of the camera image of the left rearward lateral camera 102a is set automatically to be narrow so that it does not extend far outward in the leftward direction.

If it is found in step S121 that the three-image display mode is selected, the controller 113 proceeds to step S131 where it checks the range in which the absolute value |θ| of the steering angle θ lies. If the absolute value |θ| of the steering angle is equal to or larger than a prescribed value θ2, the controller 113 proceeds to step S132 and sets the display regions to be exsected for displaying the three-image screen (1). The controller 113 then sends a command to the display area setting unit 111 instructing it to exsect the display areas and a command to the image combining unit 112 instructing which arrangement method to use. The display area setting unit 111 receives the command, exsects the specified display areas from the camera images, and sends the exsected display areas to the image combining unit 112. For example, if the steering direction is to the left, the display area setting unit 111 exsects display areas like the display areas R′a, R′c, and Rb indicated with broken-line frames in FIGS. 6A, 6B, and 6C and sends the display areas R′a, R′c, R′b to the image combining unit 112. If the absolute value |θ| of the steering angle is equal to or larger than a prescribed value θ1 and less than the prescribed value θ2, the controller 113 proceeds to step S133 and sets the display regions to be exsected in order to display the three-image screen (2). The controller 113 then sends a command to the display area setting unit 111 instructing it to exsect the display areas and a command to the image combining unit 112 instructing which arrangement method to use. The display area setting unit 111 receives the command, exsects the specified display areas from the camera images, and sends the exsected display areas to the image combining unit 112. For example, if the steering direction is to the left, the display area setting unit 111 exsects display areas like the display areas R′a, R′c, and Rb indicated with broken-line frames in FIGS. 7A to 7C and sends the display areas R′a, R′c, R′b to the image combining unit 112. If the absolute value |θ| of the steering angle is equal to or larger than 0 but less than the prescribed value θ1, the controller 113 proceeds to step S134 and sets the display regions to be exsected in order to display the three-image screen (3). The controller 113 then sends a command to the display area setting unit 111 instructing it to exsect the display areas and a command to the image combining unit 112 instructing which arrangement method to use. The display area setting unit 111 receives the command, exsects the specified display areas from the camera images, and sends the exsected display areas to the image combining unit 112. For example, if the steering direction is to the left, the display area setting unit 111 exsects display areas like the display areas R′a, R′c, and Rb indicated with broken-line frames in FIGS. 8A to 8C and sends the display areas R′a, R′c, R′b to the image combining unit 112. After steps S132, S133, and S134, control proceeds to step S108.

Steps S131 to S134 serve to automatically change the display areas of the camera images used in the three-image screens in accordance with the changes in the steering state of the vehicle. For example, when the vehicle moves from a stage in which it is approaching a parking space with a large steering angle to a stage in which it is moving in reverse within the parking space with a small steering angle, these steps serve to change the display state in the manner explained regarding FIGS. 6 to 8. In the stage of approaching the parking space, the rearward lateral camera on the side corresponding to the steering direction is needed to grasp the position of the parking space. In this case, the display areas are set automatically such that the display areas of the left rearward lateral camera 102a and the right rearward lateral camera 102c are both large in the longitudinal direction and the display area of the camera image of the rear camera 102b is limited to the vicinity of the rear end of the vehicle in the longitudinal direction. In the stage of backing within the parking space, an image providing rearward depth needs to be exsected from the rear camera image in order to determine if there are obstacles in the way and check the distance to the wheel stop or rear parking space line. In this embodiment, the display areas are automatically set such that the display area exsected from the camera image of the rear camera 102b is large and provides even more rearward depth across the entire width of the vehicle and the display areas exsected from the camera images of the left rearward lateral camera 102a and the right rearward lateral camera 102c are small portions of the forward side of the images.

FIG. 11 is a flowchart for explaining step S204 of FIG. 9 in detail. After step S203, the controller 113 proceeds to step S221 and checks whether the driver has selected the two-image display mode or the three-image display mode based on the results of step S202, in which the status of the image count selector switch 122 is detected. If the two-image selection switch 122a is on, the controller 113 proceeds to step S222. If the three-image selection switch 122b is on, the controller 113 proceeds to step S231. In step S222, the controller 113 checks if the steering direction is to the left or to the right. If the steering direction is to the left or in the center, the controller 113 proceeds to step S223 and selects the camera images of the left rearward lateral camera 102a and the rear camera 102b as the camera images to display on the display 103. If the steering direction is to the right, the controller 113 proceeds to step S224 and selects the camera images of the right rearward lateral camera 102c and the rear camera 102b as the camera images to display on the display 103. After steps S223 and S224, control proceeds to step S225. In step S225, the controller 113 checks the setting position of the display area selector switch 124. If the driver has selected position 1, the controller 113 proceeds to step S226 and sets the display regions to be exsected for displaying the two-image screen (1) for the side corresponding to the steering direction. The controller 113 then sends a command to the display area setting unit 111 instructing it to exsect the display areas and a command to the image combining unit 112 instructing which arrangement method to use. The display area setting unit 111 receives the command, exsects the specified display areas from the specified camera images, and sends the exsected display areas to the image combining unit 112. For example, if the steering direction is to the left, the display area setting unit 111 exsects display areas like the display areas Ra, Rb indicated with broken-line frames in FIGS. 3A and 3B and sends the display areas Ra, Rb to the image combining unit 112. If the driver has selected position 2, the controller 113 proceeds to step S227 and sets the display regions to be exsected for displaying the two-image screen (2) for the side corresponding to the steering direction. The controller 113 then sends a command to the display area setting unit 111 instructing it to exsect the display areas and a command to the image combining unit 112 instructing which arrangement method to use. The display area setting unit 111 receives the command, exsects the specified display areas from the specified camera images, and sends the exsected display areas to the image combining unit 112. For example, if the steering direction is to the left, the display area setting unit 111 exsects display areas like the display areas Ra, Rb indicated with broken-line frames in FIGS. 4A and 4B and sends the display areas Ra, Rb to the image combining unit 112. If the driver has selected position 3, the controller 113 proceeds to step S228 and sets the display regions to be exsected for displaying the two-image screen (3) for the side corresponding to the steering direction. The controller 113 then sends a command to the display area setting unit 111 instructing it to exsect the display areas and a command to the image combining unit 112 instructing which arrangement method to use. The display area setting unit 111 receives the command, exsects the specified display areas from the specified camera images, and sends the exsected display areas to the image combining unit 112. For example, if the steering direction is to the left, the display area setting unit 111 exsects display areas like the display areas Ra, Rb indicated with broken-line frames in FIGS. 5A and 5B and sends the display areas Ra, Rb to the image combining unit 112. After steps S226, S227, and S228, control proceeds to step S205. Steps S222 to S228 serve to change the display areas of the two-image screen in accordance with the operation of the display area selector switch 124 by the driver. If it is found in step S221 that the three-image display mode is selected, the controller 113 proceeds to step S331 where it checks the position of the display area selector switch 124. If the driver has selected position 1, the controller 113 proceeds to step S232 and sets the display regions to be exsected for displaying the three-image screen (1). The controller 113 then sends a command to the display area setting unit 111 instructing it to exsect the display areas and a command to the image combining unit 112 instructing which arrangement method to use. The display area setting unit 111 receives the command, exsects the specified display areas from the camera images, and sends the exsected display areas to the image combining unit 112. For example, if the steering direction is to the left, the display area setting unit 111 exsects display areas like the display areas R′a, R′c, and R′b indicated with broken-line frames in FIGS. 6A to 6C and sends the display areas R′a, R′c, R′b to the image combining unit 112. If the driver has selected position 2, the controller 113 proceeds to step S233 and sets the display regions to be exsected for displaying the three-image screen (2). The controller 113 then sends a command to the display area setting unit 111 instructing it to exsect the display areas and a command to the image combining unit 112 instructing which arrangement method to use. The display area setting unit 111 receives the command, exsects the specified display areas from the specified camera images, and sends the exsected display areas to the image combining unit 112. For example, if the steering direction is to the left, the display area setting unit 111 exsects display areas like the display areas R′a, R′c, and Rb indicated with broken-line frames in FIGS. 7A to 7C and sends the display areas R′a, R′c, R′b to the image combining unit 112. If the driver has selected position 3, the controller 113 proceeds to step S234 and sets the display regions to be exsected for displaying the three-image screen (3). The controller 113 then sends a command to the display area setting unit 111 instructing it to exsect the display areas and a command to the image combining unit 112 instructing which arrangement method to use. The display area setting unit 111 receives the command, exsects the specified display areas from the specified camera images, and sends the exsected display areas to the image combining unit 112. For example, if the steering direction is to the left, the display area setting unit 111 exsects display areas like the display areas R′a, R′c, and Rb indicated with broken-line frames in FIGS. 8A to 8C and sends the display areas R′a, R′c, R′b to the image combining unit 112. After steps S232, S233, and S234, control proceeds to step S205. Steps S232 to S234 serve to change the display areas of the three-image screen as appropriate in accordance with the operation of the display area selector switch 124 by the driver.

The gearshift position sensor 104 and the steering angle sensor 105 of this embodiment constitute a steering state detecting unit and the two-image selection switch 122a and the three-image selection switch 122b constitute an image count selector switch. The rear camera 102b corresponds to the first camera of the present invention, the left rearward lateral camera 102a corresponds to the second camera of the present invention, and the right rearward lateral camera 102c corresponds to the third camera of the present invention. Steps S122 to S124 and steps S222 to S224 of the flowcharts can also be executed by an image selecting unit. Steps S125 to S128, steps S131 to S134, steps S225 to S228, and steps S231 to S234 can also be executed by the display region setting unit.

With this embodiment, a plurality of images obtained with a plurality of cameras can be displayed on a display in such a manner that the proportion of each image that is displayed can be varied. The displayed proportion of each image is varied based on the steering state imposed by the driver. For example, in the Auto mode, large proportions of the image are exsected automatically from the camera images that are necessary based on the steering state of the vehicle and small proportions are exsected from the camera images that are not so important at that point in time. The exsected display areas are combined onto a single screen in a left-right arrangement similar to that viewed by the driver when he or she uses the door mirrors and the rearview mirror, the display state (i.e., size and arrangement of the display areas) is switched automatically among the two-image screens (1), (2), (3) or the three-image screens (1), (2), (3), and the display areas are displayed on the screen 103 without reducing the magnification of the images. Consequently, the rearward areas behind the left and right side sections of the vehicle and the area directly behind the vehicle can be monitored easily. Meanwhile, in the Manual mode, the predetermined display areas exsected from the camera images are changed as appropriate in accordance with the operation of the image count selector switch 122 and the display area selector switch 124 by the driver. The exsected display areas are combined onto a single screen in a left-right arrangement similar to that viewed by the driver when he or she uses the door mirrors and the rearview mirror, the display state (i.e., size and arrangement of the display areas) is set to one of the two-image screens (1), (2), (3) or one of the three-image screens (1), (2), (3), and the display areas are displayed on the screen 3 without reducing the magnification of the images. Consequently, the rearward areas behind the left and right side sections of the vehicle and the area directly behind the vehicle can be monitored easily. When the two-image display mode is used, the rearward lateral camera image on the side corresponding to the steering direction is selected automatically based on the steering angle regardless of whether the surroundings monitoring system is in Auto mode or Manual mode. Thus, the burden of selecting which camera images to display is not placed on the driver. Furthermore, since in both the two-image display mode and the three-image display mode the arrangement of the camera images displayed on the display 103 is maintained irregardless of the steering state or the display area selector switch 124, the relationship between the images is consistent and easy for the driver to understand even when the display areas are switched among the two-image screens (1), (2), (3) or the three-image screens (1), (2), (3).

### Second Embodiment

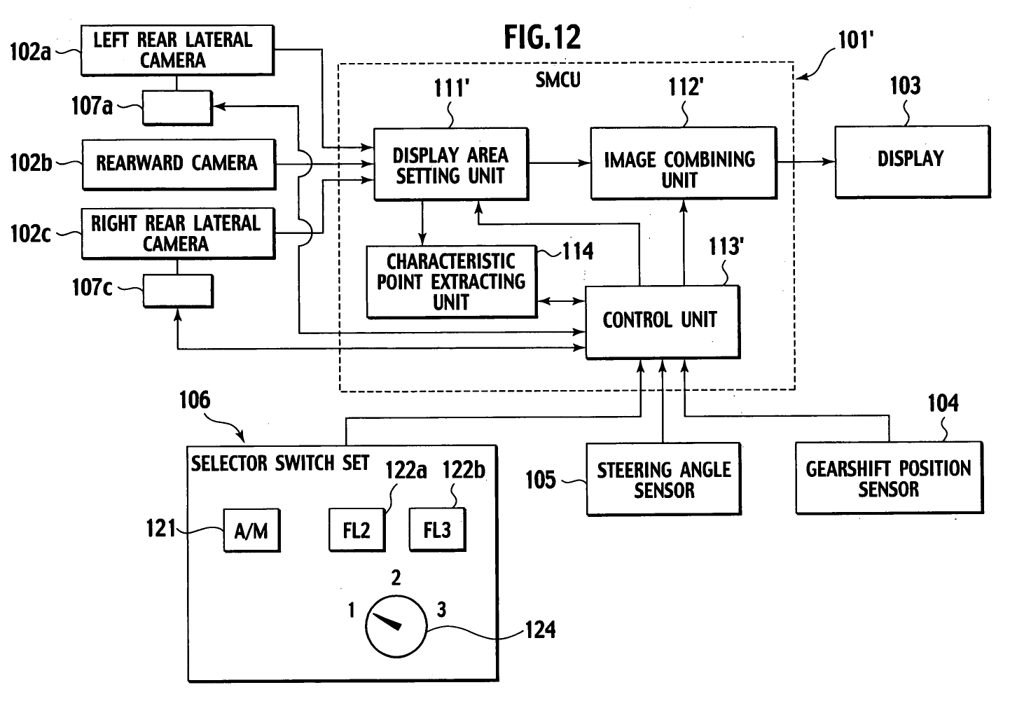

A second embodiment of the present invention will now be described. FIG. 12 is a block diagram of a vehicle surroundings monitoring system in accordance with the second embodiment. In a vehicle surroundings monitoring system in accordance with this embodiment, the camera images from the left rearward lateral camera 102a, the rear camera 102b, and the right rearward lateral camera 102c are fed to the SMCU 101′, the SMCU 101′ processes the images, and the processed images are displayed on the display 103. An actuator 107a, 107c provided with an angle sensor is mounted to each of the left rearward lateral camera 102a and the right rearward lateral camera 102c, and the control unit 113′ (discussed later) of the SMCU 101′ can change the photographing direction of the rearward lateral cameras in the horizontal and vertical directions by operating the actuators. The SMCU 101′ is connected to a selector switch set 106 that enables the driver to change the method of displaying the camera images on the display 103 and a gearshift position sensor 104 and a steering angle sensor 105 that detect the reverse state of the vehicle.

The SMCU 101′ comprises the following: a display area setting unit 111′ configured to acquire camera images from the three cameras 102a, 102b, 102c and exsect an area of each camera image to be displayed on the display 103; a feature extracting unit 114 configured to process the display areas exsected from the camera images, extract a distinctive feature existing on the ground, and extract ends of the extracted features; an image combining unit 112′ configured to combine the display areas in a prescribed arrangement on a single screen; and a control unit (controller) 113′ configured to issue commands to the display area setting unit 111 specifying the display areas to be exsected from the camera images and commands to the image combining unit 112 specifying which method to use for arranging the display areas, the commands being based on signals from the steering angle sensor 105 and the selector switch 106.

The controller 113′ switches between Auto mode and Manual mode and sets whether to display a two-image screen or a three-image screen on the display 103 based on signals from the selector switch set 106. When the two-image display mode is selected while in Manual mode, the controller 113′ automatically controls the selection of either a combination of the camera images of the left rearward lateral camera 102a and the rear camera 102b or a combination of the camera images of the right rearward lateral camera 102c and the rear camera 102b, the selection being based on the steering angle signal from the steering angle sensor 105.

Additionally, when in Manual mode, the controller 113′ controls the photographing direction of the left and right rearward lateral cameras 102a, 102c in accordance with the signal from the display area selector switch 124 and this control is executed in both the two-image display mode and the three-image display mode. When the two-image display mode is selected, the left or right rearward lateral camera 102a, 102c, i.e., the rearward lateral camera on the side corresponding to the steering direction, is set to, for example, one of three different angles toward the transversely outward direction based on the setting position of the display area selector switch 124. For example, the direction of the rearward lateral camera might be set to an angle of 10 degrees toward the transversely outward direction when the display area selector switch 124 is set to position 1, a smaller angle of 5 degrees toward the transversely outward direction when the display area selector switch 124 is set to position 2, and a substantially directly rearward direction when the display area selector switch 124 is set to position 3. When the three-image display mode is selected, both the left and right rearward lateral cameras 102a, 102c, are set to, for example, one of three different angles in the vertical direction based on the setting position of the display area selector switch 124. For example, the direction of the rearward lateral cameras might be set to an angle of 10 degrees toward the downward direction when the display area selector switch 124 is set to position 1, a smaller angle of 5 degrees toward the downward direction when the display area selector switch 124 is set to position 2, and a substantially horizontally rearward direction when the display area selector switch 124 is set to position 3. In both the two-image display mode and the three-image display mode, the controller 113′ sends commands to the display area setting unit 111′ specifying the display areas to be exsected from the camera images and commands to the image combining unit 112′ specifying which arrangement method to use, the commands being based on the setting position of the display area selector switch 124.

When the two-image display mode is selected while in Auto mode, the controller 113′ automatically controls the selection of either a combination of the camera images of the left rearward lateral camera 102a and the rear camera 102b or a combination of the camera images of the right rearward lateral camera 102c and the rear camera 102b, the selection being based on the steering angle signal from the steering angle sensor 105. Additionally, in both the two-image display mode and the three-image display mode, the controller 113′ controls the photographing direction of the left and right rearward lateral cameras 102a, 102c in accordance with the steering angle signal. Also, in both the two-image display mode and the three-image display mode, the controller 113′ sends commands to the display area setting unit 111′ specifying the display areas to be exsected from the camera images and commands to the image combining unit 112′ specifying which arrangement method to use, the commands being based on the steering angle signal.

The procedure for controlling the photographing direction of the left and right rearward lateral cameras 102a, 102b based on the steering angle θ in Auto mode will now be described. When the two-image display mode is selected, the rearward lateral camera on the side corresponding to the steering direction is automatically set to one of three angles toward the transversely outward direction depending on the steering angle. For example, the rearward lateral camera is set to a substantially directly rearward direction when the steering angle θ is in the range 0≦|θ|<θ1, a slightly outward angle of approximately 5 degrees toward the transversely outward direction when the steering angle θ is in the range θ1≦|θ|<θ2, and further outward angle approximately 10 degrees toward the transversely outward direction when the steering angle θ is in the range θ2≦|θ|. When the three-image display mode is selected, both the left and right rearward lateral cameras are automatically set to one of three angles in the vertical direction depending on the steering angle. For example, the rearward lateral cameras are set to a substantially horizontally rearward direction when the steering angle θ is in the range θ≦|θ|<θ1, a slightly downward angle of approximately 5 degrees toward the downward direction when the steering angle θ is in the range θ1<|θ|<θ2, and further downward angle approximately 10 degrees toward the downward direction when the steering angle θ is in the range θ2≦|θ|.

The method by which the display area setting unit 111 exsects the display areas from the camera images will now be described. When the two-image display mode is selected, the display areas can be exsected from the camera images in the same manner as in the first embodiment, the only difference being that actuators 107a, 107c provided with angle sensors are used to control the photographing directions of the left and right rear lateral cameras 102a, 102c in accordance with the position to which the driver sets the display area selector switch 124 when in Manual mode and in accordance with the steering angle signal when in Auto mode.

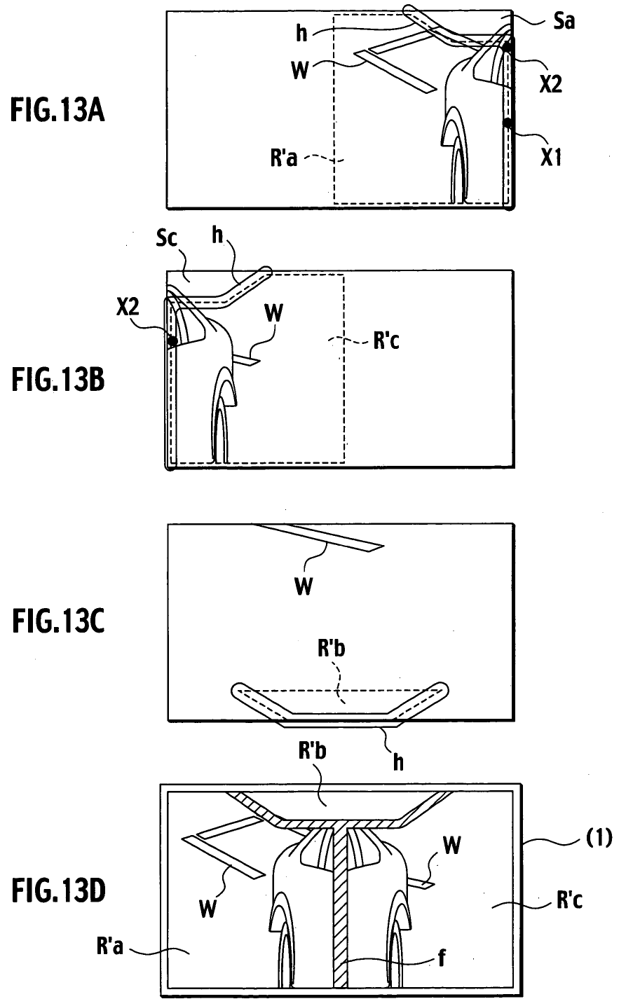

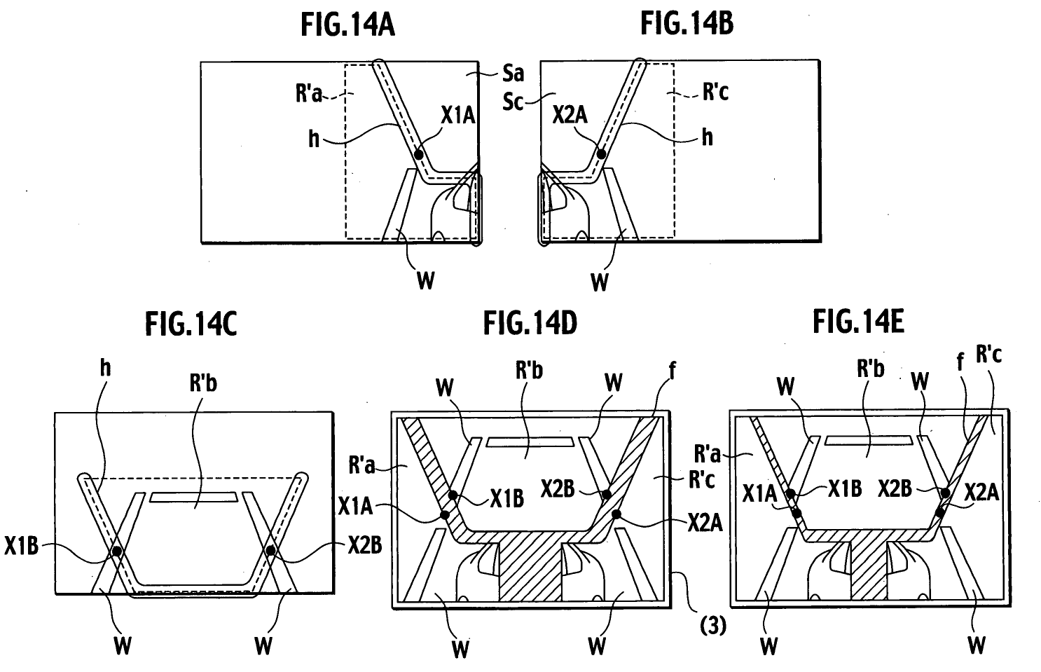

The method by which the display areas are exsected when the vehicle surroundings monitoring system is in the three-image display mode will now be described using FIGS. 13A to 13D and FIGS. 14A to 14E. The method will be described based on a case in which the vehicle surroundings monitoring system is in Auto mode. FIGS. 13A, 13B, and 13C show the images photographed by the left rearward lateral camera, the right rearward lateral camera, and the rear camera when the steering angle θ is large, i.e., θ2≦|θ|. The areas enclosed in the broken-line frames in FIGS. 13A, 13B, and 13C are the display areas R′a, R′c, R′b that will be exsected by the display area setting unit 111. When the steering angle is large, the actuators 107a, 107c (equipped with angle sensors) are driven so as to move the photographing direction of the left and right rearward lateral cameras 102a, 102c 10 degrees downward from the horizontal direction so that the area behind the rear wheels is put into the field of view and the positional relationship between the anticipated path of the rear wheels and the white lines of the parking space can be readily apprehended.

The display areas R′a and R′c are left-right symmetrical and cover the entire vertical dimension of the camera images except for trapezoidal cutaway sections Sa, Sc provided on upper rearward portions near the vehicle body. In the left-to-right widthwise direction of the camera images, the display areas R′a and R′c cover approximately half the width of the camera image on the side near the vehicle body. In the rear camera image shown in FIG. 13C, the display area R′b is located toward the rear end of the vehicle body and has the shape of an upside-down isosceles trapezoid. The height (length in the longitudinal direction of the vehicle) and the horizontal width of the isosceles trapezoid are set to be small. The combined image shown in FIG. 13D is the three-image screen (1) obtained with this embodiment. In the three-image screen (1), the display areas are combined on a single screen such that the display areas R′a and R′c are arranged side by side, the display area R′b is arranged in an intermediate position there-above, and the boundary region f there-between is treated with a gap processing.

FIGS. 14A and 14B show the images obtained with the left and right rearward lateral cameras and FIG. 14C shows the image obtained with the rear camera when the steering angle is 0. When the camera angle θ is small (i.e., when θ≦|θ|<θ1), the actuators 107a, 107c (equipped with angle sensors) are driven so as to move the photographing direction of the left and right rearward lateral cameras 102a, 102c to the horizontal direction so that the entire depth of the parking space behind the vehicle is put into the field of view and the parallel relationship between the vehicle body (as opposed to the anticipated path of the rear wheels) and the white lines of the parking space can be readily apprehended. While the vertical dimensions of the display areas R′a and R′c are the same as the vertical dimensions of the camera images, the difference between FIG. 14A, 14B and FIG. 13A, 13B are that, as shown in FIGS. 14A and 14B, the heights and horizontal widths of the trapezoidal cutaway sections Sa, Sc are larger and heights span across approximately the upper two-thirds of the vertical dimension of the camera images. Additionally, the angles of the diagonal sides of the trapezoidal cutaway sections Sa, Sc are closer to vertical. As shown in FIG. 14C, the length of the display area is also set to approximately two-thirds of that of the camera image.

The combined image shown in FIG. 14D is the three-image screen (3) obtained with this embodiment. Although omitted from the figures, when the steering angle θ is in the range θ1≦|θ|<θ2, the vertical dimensions of the display areas R′a and R′c are the same as the vertical dimensions of the camera images and the heights of the cutaway sections Sa and Sc span across approximately the upper one-half of the vertical dimensions of the camera images. The height of the display area R′b is also set to approximately one-half of the vertical dimension of the camera image. When display areas R′a, R′c, and Rb set in this manner are combined onto a single screen with positional relationships similar to those of FIGS. 13D and 14D, the result is the three-image screen (2). The display states of the three-image screens (1), (2), (3) are the same when three-image display mode is used in Manual mode.

Additionally, when the three-image display mode is selected while in Auto mode, the controller 113′ commands the feature extracting unit 114 to extract a feature alignment point. The feature extracting unit 114 executes edge detection processing with respect to the display area exsected from each camera image so as to extract a feature existing on the ground, e.g., a white line. If a feature exists in the display area, the feature extracting unit 114 extracts a “feature end” as a feature alignment point. If the feature end is contained in the display area of more than one of the camera images, the controller 113′ commands the image combining unit 112′ to adjust the arrangement of the camera images such that the feature ends draw closer together. The display area setting unit 111′, the image combining unit 112′, and the feature extracting unit 114 can be realized with a single image processor and an image memory. The controller 113 can be realized with a CPU (central processing unit), a ROM, and a RAM.

The method by which the feature extracting unit 114 detects features and feature ends will now be described. The method will be described based on an example in which the 0 three-image screen (3) is displayed. A white line W indicating a parking space appears in the left rearward lateral camera image shown in FIG. 14A, the right rearward lateral camera image shown in FIG. 14B, and the rear camera image 14C. The feature extracting unit 114 applies a well-known edge detection processing to the display areas exsected from the camera images by the display area setting unit 111′ and extracts an outline of the white line, rope, or other item that demarcates the parking space on the ground. The feature extracting unit 114 then extracts the intersection points between the extracted outline and the adjacent image perimeter h of the set display areas and recognizes the intersection points as “feature ends X”, e.g., points X1B and X2B in FIG. 14C. When the extracted outline and the adjacent image perimeter h do not intersect directly, as exemplified in FIGS. 14A and 14B, the intersection point between the adjacent image perimeter h and an extension line of the extracted outline is established as the feature end X (e.g., X1A and X2A). When a feature end(s) X is obtained, the feature extracting unit 114 sends the control unit 113′ information describing which camera photographed the image in which the feature end X was obtained, the position coordinates of the outline of the white line or rope (or other item), and the position coordinates of the feature end X. When a feature end X is obtained, the controller 113′ stores the coordinates that describe the position of the feature end X within that particular camera image.

The controller 113′ then reads the angle signals from the actuators 107a, 107c (equipped with angle sensors) of the left and right rearward lateral cameras 102a, 102b and detects the photographing direction of each camera. The fixed photographing direction of the rear camera 102b, mounting positions of all three cameras, and data describing the focal lengths of the cameras are stored in the controller 113′ in advance. The controller 113′ calculates the actual position of the white line (or rope or other item) with respect to a prescribed rear section reference position of the vehicle 131 based on the focal length data of the cameras, the photographing directions of the left and right rearward lateral cameras 102a, 102c, and the image position coordinates of the extracted outline. If the calculated position of the white line with respect to the rear section reference position is the same for each camera image, the controller 113′ determines that the outlines extracted from the display areas of the camera images correspond to the same white line and issues a command to the image combining unit 112 instructing it to adjust the positions of the images on the three-image screen such that the feature ends X move closer together.

The function of the image combining unit 112′ is basically the same as in the first embodiment. The difference is that when the three-image display mode is selected while in Auto mode, the image combining unit 112′ adjusts the positions of the display areas R′a and R′c horizontally based on a position adjustment command from the controller 113′ such that the feature ends X at the adjacent image perimeter h of the display areas R′a, R′c move closer to the feature end X corresponding to the adjacent image perimeter h of the display area R′b.

FIG. 14D shows the result obtained when the positions of the display areas R′a and R′c are adjusted such that the feature end X1A of the display area R′a moves closer to the feature end X1B of the display area R′b and the feature end X2A of the display area R′c moves close' to the feature end X2B of the display area R′b. FIG. 14E shows the tentative arrangement of the three-image screen (3) before the position adjustment. In the state shown in FIG. 14E, the feature ends X1B and X2B of the display area R′b are horizontally out of place with respect to the feature ends X1A and X2A of the display areas R′a and R′c, respectively, and the display does not seem natural to the driver. In FIG. 14D, the display seems natural because the positions of the display areas R′a and R′c have been shifted horizontally such that the white lines appear to be connected toward the rear.

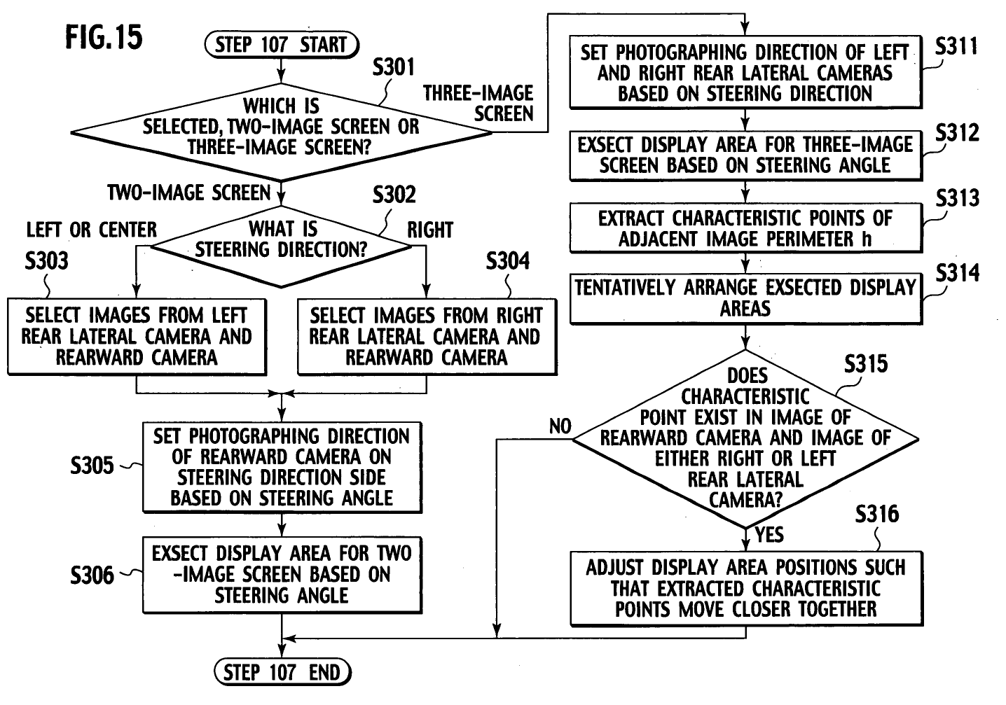

The flow of the image display switching control executed by this embodiment will now be described. The flowchart of the overall flow of the image display switching control is the same as shown in FIG. 9 for the first embodiment. When the system is in Auto mode, the detailed flowchart corresponding to step S107 of FIG. 9 is replaced with the flowchart shown in FIG. 15. When steps of FIG. 9 are mentioned in this explanation, the reference numerals of the display area setting unit 111, the image combining unit 112, and the controller 113 are amended to 111′, 112′, and 113′, respectively.

After step S106, the controller 113′ proceeds to step S301 and checks whether the driver has selected the two-image display mode or the three-image display mode based on the results of step S106, in which the status of the image count selector switch 122 is detected. If the two-image selection switch 122a is on, the controller 113′ proceeds to step S302. If the three-image selection switch 122b is on, the controller 113′ proceeds to step S311. In step S302, the controller 113′ checks if the steering direction is to the left or to the right. If the steering direction is to the left or in the center, the controller 113′ proceeds to step S303 and selects the camera images of the left rearward lateral camera 102a and the rear camera 102b as the camera images to display on the display 103. If the steering direction is to the right, the controller 113′ proceeds to step S304 and selects the camera images of the right rearward lateral camera 102c and the rear camera 102b as the camera images to display on the display 103. After steps S303 and S304, control proceeds to step S305. In step S305, the controller 113′ sets the horizontal photographing direction of the rearward lateral camera on the side corresponding to the steering direction based on the steering angle θ. In step S306, the controller 113′ sets the display areas to be exsected from the images obtained with the rearward lateral camera on the steering direction side and the rear camera, commands the display area setting unit 111′ to exsect those display areas, and sends a command to the image combining unit 112′ specifying the arrangement method. The display area setting unit 111′ receives the command, exsects the display areas, and sends the display areas to the image combining unit 112′. As a result of steps S302 to S306, the display area setting unit 111′ exsects display areas from the camera images so as to display the two-image screen (1) corresponding to the steering direction side when the steering angle θ is in the range θ2≦|θ|, the two-image screen (2) corresponding to the steering direction side when the steering angle θ is in the range θ1≦|θ51 <θ2, and the two-image screen (3) corresponding to the steering direction side when the steering angle θ is in the range θ≦|θ|<θ1. After step S306, control proceeds to step S108. The steps S302 to S306 serve to automatically change the display areas of the camera images used in the two-image screens in accordance with the changes in the steering state of the vehicle as the vehicle moves from a stage in which it is approaching a parking space with a large steering angle to a stage in which it is moving in reverse within the parking space with a small steering angle. In the stage of approaching the parking space, the rearward lateral camera on the side corresponding to the steering direction is needed to grasp the anticipated path of the rear wheels and the position of the parking space. For example, if the vehicle is backing to the left, the display areas are automatically set such that the display area exsected from the camera image of the left rearward lateral camera 102a is shifted slightly to the left so that it is expanded outward from the left side of the vehicle and the display area exsected from the camera image of the rear camera 102b is made small.

In the stage of backing within the parking space, a display area providing rearward depth across the entire width of the vehicle needs to be exsected from the rear camera image in order to determine if there are obstacles in the way and check the distance to the wheel stop or rear parking space line. In this case, the display areas are set automatically such that the display area exsected from the camera image obtained with the rear camera 102b is large from left to right and the display area exsected from the camera image obtained with the left rearward lateral camera 102a contains the region directly behind the side part of the vehicle. Thus, it is easy to determine if the vehicle body is parallel with the parking space lines W in the longitudinal direction and the display areas contain little of the region located outward from the left side of the vehicle because it is not so important to view that region.

If it determines that the three-image display mode has been selected in step S301, the controller 113′ proceeds to step S311 where it sets the vertical photographing direction of the left and right rearward lateral cameras 102a, 102c based on the steering angle B. In step S312, the controller 113‘sets the display areas R’ a, R′c, R′b to be exsected from the images obtained with the left and right rearward lateral cameras and the rear camera, commands the display area setting unit 111′ to exsect those display areas, and sends a command to the image combining unit 112′ specifying the arrangement method. The display area setting unit 111′ receives the command, exsects the display areas, and sends the display areas to the image combining unit 112′ and the feature extracting unit 114. As a result of step S312, the display area setting unit 111′ exsects display areas from the camera images so as to display the three-image screen (1) on the display 103 when the steering angle θ is in the range θ2≦|θ|, the three-image screen (2) when the steering angle θ is in the range θ1≦|θ|<θ2, and the three-image screen (3) corresponding to the steering direction side when the steering angle, is in the range 0≦|θ|<θ1.

In step S313, the feature extracting unit 114 executes edge processing with respect to the display areas exsected in step S312 and extracts feature alignment points. More specifically, it detects the outline of the white line or rope that indicates the parking space and extracts feature ends X (feature alignment points), which are intersection points between the outline and the adjacent image perimeter h or between an extension line of the outline toward the adjacent image perimeter h and the adjacent image perimeter h. The feature extracting unit 114 sends information indicating the presence or absence of feature ends X and the position coordinates of the feature ends X (if present) to the controller 113′. In step S314, the image combining unit 112′ tentatively arranges the display areas of the camera images on a single screen. In step S315, the controller 113′ checks if the extracted feature ends X (feature alignment points) exist on the adjacent image perimeters h of the display area R′b and the display area R′a or on the adjacent image perimeters h of the display area R′b and the display area R′c and if the extracted features ends belong to the same outline. If feature ends X (feature alignment points) belonging to the same outline are found to exist in the display area R′b and the display area R′a or Rc, then control proceeds to step S316. Otherwise, control proceeds to step S108. In step S316, the image combining unit 112′ adjusts the horizontal (left-right) positions of the display areas R′a and R′c such that the display positions of the feature ends X (feature alignment points) of the display area exsected from the rear camera image and the feature ends X (feature alignment points) of the display areas exsected from the adjacent left and right rearward lateral camera images draw closer together. After step S316, control proceeds to step S108.

The steps S311 to S316 serve to automatically change the display areas of the camera images used in the three-image screens in accordance with the changes in the steering state of the vehicle as the vehicle moves from a stage in which it is approaching a parking space with a large steering angle to a stage in which it is moving in reverse within the parking space with a small steering angle. In the stage of approaching the parking space, the rearward lateral cameras are needed to grasp the anticipated path of the rear wheels and the position of the parking space. In this embodiment, the directions of the left and right rearward lateral cameras 102a, 102c are automatically tilted downward to make it easier to fit the rear wheels and the ground located behind the side portions of the vehicle body into the camera images and the display areas are set automatically such that the display areas of the camera images of the left and right rearward lateral cameras 102a, 102b are large and the display area of the camera image of rear camera 102b is small. In the stage of backing within the parking space, a display area providing rearward depth across the entire width of the vehicle needs to be exsected from the rear camera image in order to determine if there are obstacles in the way and check the distance to the wheel stop or rear parking space line. In this embodiment, the display area of the camera image of the rear camera 102b is set automatically to be wide from left to right along the longitudinal direction of the vehicle body. Conversely, the left and right rearward lateral cameras 102a, 102c are adjusted to photograph in the horizontally rearward direction (no tilt) to make it easier for the driver to apprehend the parallel relationship between the white lines and the longitudinal direction of the vehicle body and the display areas thereof are set automatically to be narrow so that they do not extend far outward in the leftward or rightward direction.

Although a detailed flowchart explaining the control operations executed in step S204 when the vehicle surroundings monitoring system is in Manual mode is omitted from the drawings, such a flowchart can be realized by inserting two additional steps into the flowchart of FIG. 11: a step that sets the photographing direction of the rearward lateral camera on the side corresponding to the steering direction in accordance with the position of the display area selector switch between step S225 and steps S226 to S228; and a step that sets the photographing directions of the left and right rearward lateral cameras in accordance with the position of the display area selector switch between step S331 and steps S232 to S234.

The gearshift position sensor 104 and the steering angle sensor 105 of this embodiment constitute a steering state detecting unit and the two-image selection switch 122a and the three-image selection switch 122b constitute an image count selector switch. The rear camera 102b corresponds to the first camera of the present invention, the left rearward lateral camera 102a corresponds to the second camera of the present invention, and the right rearward lateral camera 102c corresponds to the third camera of the present invention. Steps S302 to S304 and steps S222 to S224 of the flowchart constitute an image selecting unit, steps S306, S312, S225 to S228, and S231 to S234 constitute an image display region setting unit, step S313 constitutes a feature extracting unit, and steps S305 and S311 constitute an image direction setting unit.

With this embodiment, similarly to the first embodiment, when the vehicle surroundings monitoring system is in the Auto mode, large proportions of the image are exsected automatically from the camera images that are necessary based on the steering state of the vehicle and small proportions are exsected from the camera images that are not so important at that point in time. The exsected display areas are combined onto a single screen in a left-right arrangement similar to that viewed by the driver when he or she uses the door mirrors and the rearview mirror, the display state (i.e., size and arrangement of the display areas) is switched automatically among the two-image screens (1), (2), (3) or the three-image screens (1), (2), (3), and the display areas are displayed on the screen 103 without reducing the magnification of the images. Consequently, the rearward areas behind the left and right side sections of the vehicle and the area directly behind the vehicle can be monitored easily.

Meanwhile, in the Manual mode, the predetermined display areas exsected from the camera images are changed as appropriate in accordance with the operation of the image count selector switch 122 and the display area selector switch 124 by the driver. The exsected display areas are combined onto a single screen in a left-right arrangement similar to that viewed by the driver when he or she uses the door mirrors and the rearview mirror, the display state (i.e., size and arrangement of the display areas) is set to one of the two-image screens (1), (2), (3) or one of the three-image screens (1), (2), (3), and the display areas are displayed on the screen 103 without reducing the magnification of the images. Consequently, the rearward areas behind the left and right side sections of the vehicle and the area directly behind the vehicle can be monitored easily.

Similarly to the first embodiment, when the two-image display mode is used, the rearward lateral camera image on the side corresponding to the steering direction is selected automatically based on the steering angle regardless of whether the surroundings monitoring system is in Auto mode or Manual mode. Thus, the burden of selecting which camera images to display is not placed on the driver.

Furthermore, since in both the two-image display mode and the three-image display mode the arrangement of the camera images displayed on the display 103 is maintained irregardless of the steering state or the display area selector switch 124, the relationship between the images is consistent and easy for the driver to understand even when the display areas are switched among the two-image screens (1), (2), (3) or the three-image screens (1), (2), (3). Irregardless of whether the system is in the two-image display mode or the three-image display mode, when the system is in Auto mode, the photographing direction of the rearward lateral camera on the side corresponding to the steering direction is controlled in accordance with the size of the steering angle in such a manner that the larger the steering angle is, the larger the area captured by the camera of the ground surface behind the corresponding side section of the vehicle body.

Irregardless of whether the system is in the two-image display mode or the three-image display mode, when the system is in Manual mode, the photographing direction of the rearward lateral camera on the side corresponding to the steering direction is controlled in accordance with the position of the display area selector switch 124 selected by the driver in such a manner that the area captured by the camera of the ground surface behind the corresponding side section of the vehicle body is largest when position 1 is selected, an intermediate size when position 2 is selected, and smallest when position 1 is selected. Thus, in the stage of approaching a parking space, the anticipated path of the rear wheels and the position of the parking space are readily discernable on the display 103. Also, in the three-image display mode, the screen of the display 103 can be used effectively because the display areas exsected from the camera images are set and combined on a single screen in such a manner that the gaps between the display areas are small. Furthermore, when the vehicle surroundings monitoring system is in Auto mode with the three-image display mode is selected and the outlines of the white lines or other features contained in the display areas exsected from the camera images are determined to correspond to the same features, the positions of the display areas are adjusted (at the stage when the display areas are combined onto a single screen) such that the feature alignment points of the outlines at the adjacent image perimeters h of the display areas move closer together. As a result, the rearward monitoring screen can be easily understood by the driver and does not impart a feeling of unnaturalness.

### Third Embodiment

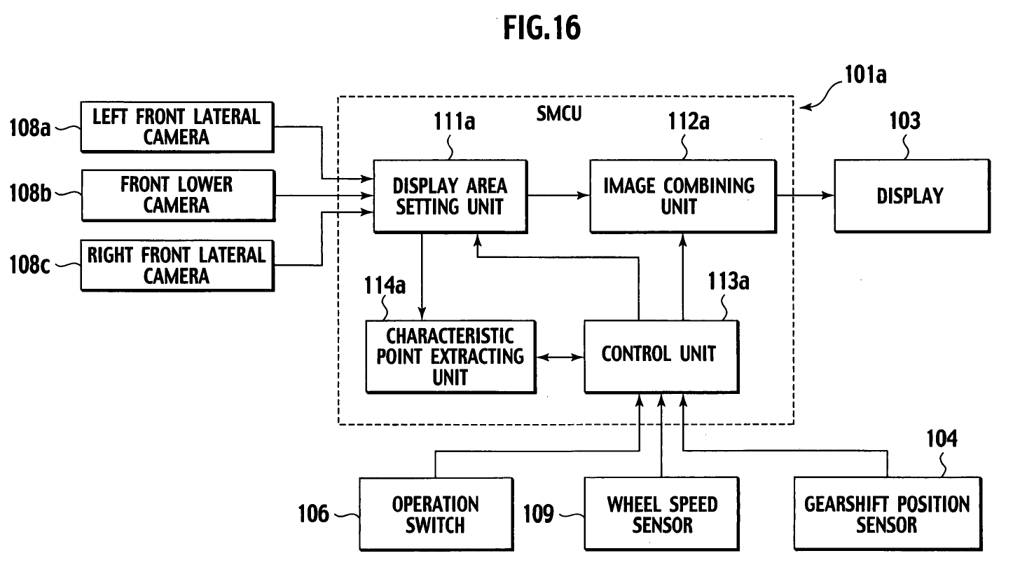

A third embodiment of the present invention will now be described. FIG. 16 is a block diagram of a vehicle surroundings monitoring system in accordance with this embodiment. A vehicle surroundings monitoring system in accordance with this embodiment is provided with three cameras: a left front end lateral camera 108a, a front lower camera 108b, and a right front end lateral camera. These cameras serve to photograph to the left of the vehicle, in the forward and downward direction of the vehicle, and to the right of the vehicle. The images obtained with the cameras are fed to an SMCU 101a to be processed and the processed images are displayed on a display 103. The SMCU 101a is connected to an operation switch 106′ with which the driver can turn the vehicle surroundings monitoring system on and off and a gearshift position sensor 104 and wheel speed sensor 109 that detect the state of the forward movement of the vehicle.

The SMCU 101a comprises the following: a display area setting unit 111a configured to acquire camera images from the three cameras 108a, 108b, 108c and exsect an area of each camera image to be displayed on the display 103; a feature extracting unit 114a configured to process the display areas exsected from the camera images, extract a distinctive feature existing on the ground, and extract ends of the extracted features; an image combining unit 112a configured to combine the display areas exsected from the camera images in a prescribed arrangement on a single screen; and a control unit (controller) 113a configured to issue commands to the display area setting unit 111a specifying the display areas to be exsected from the camera images and commands to the image combining unit 112a specifying which method to use for arranging the display areas, the commands being based on an advancement distance (described later). The display area setting unit 111a, the image combining unit 112a, and the feature extracting unit 114a can be realized with, for example, a single image processor and an image memory (neither shown in the figures). The controller 113a can be realized with, for example, a CPU, a ROM, and a RAM.

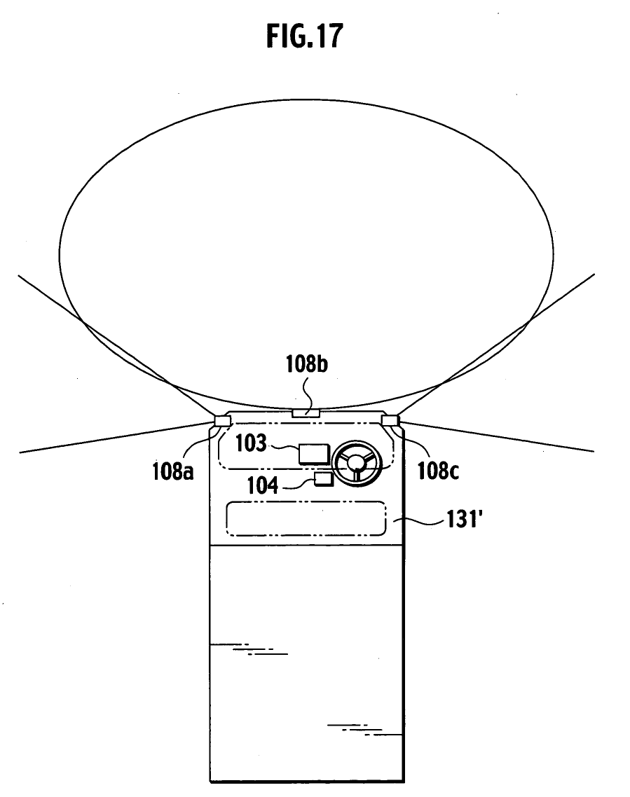

FIG. 17 shows the arrangement of the constituent components of this embodiment. The vehicle 131′ is, for example, a bus or freight vehicle having a high driver's seat. The left front end lateral camera 108a is provided on the left end of a front portion of the vehicle, e.g., on the bumper, and arranged to photograph in a substantially horizontal leftward direction. The front lower camera 108b is provided on a front portion of the vehicle at a position located approximately midway in the transverse direction of the vehicle and a midway to high in the vertical direction of the vehicle and is equipped with a wide angle lens so that it can photograph a wide range in the transverse direction of the vehicle. The right front end lateral camera 108c is provided on the right end of a front portion of the vehicle, e.g., on the bumper, and arranged to photograph in a substantially horizontal rightward direction.

The constituent features of the SMCU 101a will now be described. The vehicle surroundings monitoring system is interlocked with the ignition key switch (not shown in the figures) such that it enters a waiting mode when the ignition key switch is turned on. The vehicle surroundings monitoring function starts when the gearshift position sensor 104 detects a forward driving gearshift position and the vehicle surroundings monitoring system detects that the operation switch 106′ is in the ON state. The vehicle forward monitoring system stops monitoring the forward surroundings when it detects that the operation switch 106′ is in the OFF state. Once the system starts up, the controller 113a starts counting the pulse signals from the wheel speed sensor 109 and, based on the total of the pulse signals, calculates the advancement distance L of the vehicle 131 since the operation switch 106′ was turned on. The controller 113a commands the display area setting unit 111a to exsect display areas from the camera images; one of three different patterns of display area is selected based on the advancement distance.

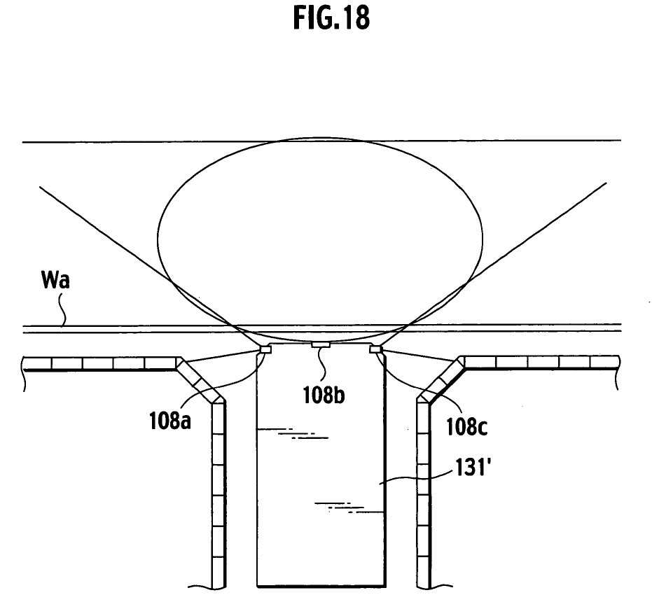

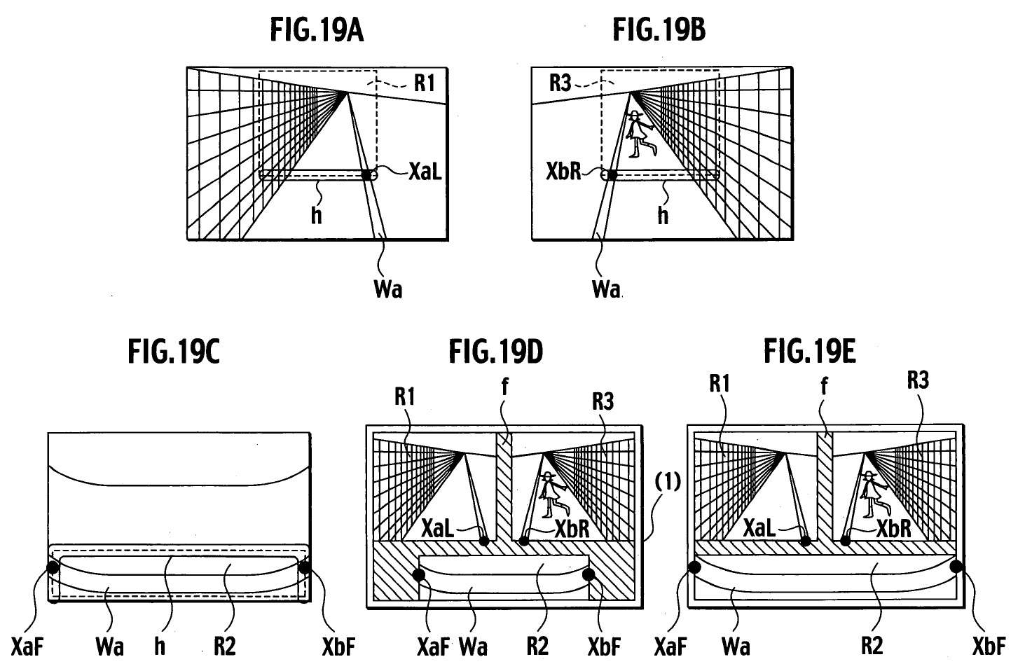

An example will now be described to illustrate how this embodiment functions when the vehicle 131′ is traveling very slowly or is stopped before an intersection where visibility is poor, as shown in FIG. 18. FIG. 19 shows an example of how the images of the three front cameras are combined onto a single screen and displayed on the display 103 when the advancement distance L is equal to or larger than 0 and less than a prescribed distance L1. The prescribed distance L1 is a distance corresponding to the width of a road shoulder or sidewalk, e.g., 0.6 m. FIG. 19A shows the camera image obtained with the left front end lateral camera 108a, FIG. 19B shows the camera image obtained with the right front end lateral camera 108c, and FIG. 19C shows the camera image obtained with the front lower camera 108b. The areas enclosed in the broken-line frames in FIGS. 19A to 19C are the display areas R1, R3, R2 that will be exsected from the camera images by the display area setting unit 111a. The display areas R1 and R3 are left-right symmetrical, located at the approximate center of the camera images in the horizontal direction, span across approximately one-half the horizontal dimension of the camera images, and span across approximately the upper two-thirds of the vertical dimension of the camera images. The display area R2 is set to span across the entire horizontal dimension of the front lower camera image shown in FIG. 19C and across approximately the lower one-third of the vertical dimension of the camera image. FIG. 19D shows the result obtained when the images are combined and displayed on a single screen with the display areas R1 and R3 arranged to the left and right of each other on an upper part of the screen, the display area R2 arranged on a lower part of the screen, and the boundary region f (indicated with cross hatching in the figure) between the images having been treated with gap processing. Hereinafter, the combined image shown in FIG. 19D will be called the “front three-image screen (1).”

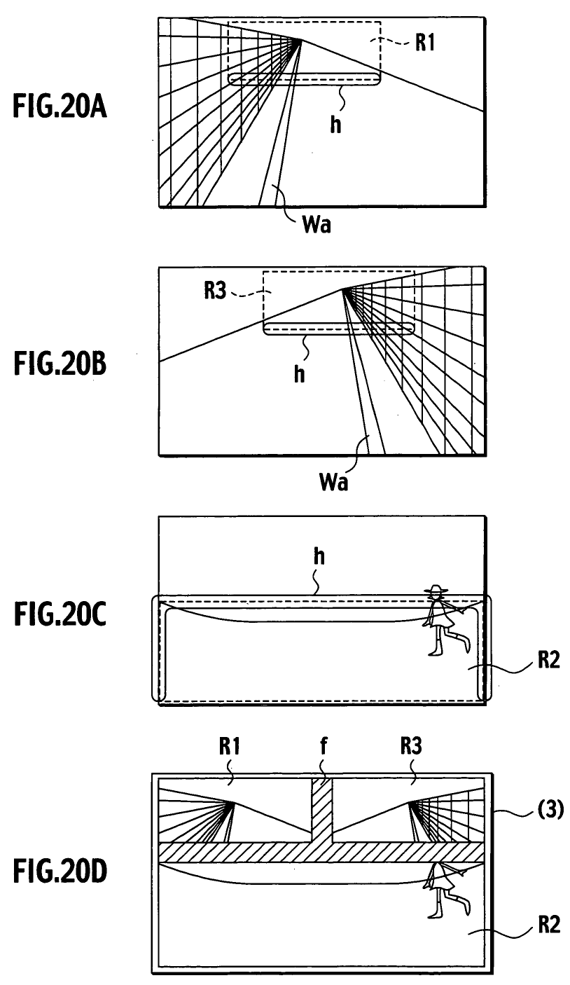

FIG. 20A to 20D show an example of how the images of the three front cameras are combined onto a single screen and displayed on the display 103 when the advancement distance L is equal to or larger than a prescribed distance L2. The prescribed distance L2 corresponds to the distance, e.g., 2m, the vehicle must advance to reach the center of the intersection. FIGS. 20A and 20B show the camera images obtained with the left and right front end lateral cameras 108a, 108c and FIG. 20C shows the camera image obtained with the front lower camera 108b. The areas enclosed in the broken-line frames in FIGS. 20A to 20C are the display areas R1, R3, R2 that will be exsected from the camera images by the display area setting unit 111a. The difference with respect to FIG. 19 is that the vertical dimension of the display areas R1 and R3 spans across approximately the upper one-third of the camera image and the vertical dimension of the display area R2 spans across approximately the lower two-thirds of the camera image.

FIG. 20D shows the result obtained when the display areas R1, R3, R2 are combined onto a single screen in a similar fashion to the front three-image screen (1); this screen is called the “front three-image screen (3).” Although omitted from the figures, in a case in which the advancement distance L is equal to or larger than the prescribed distance L1 and less than the prescribed distance L2, the vertical dimension of the display areas R1 and R3 spans across approximately the upper one-half of the camera image and the vertical dimension of the display area R2 also spans across approximately the lower one-half of the camera image. In this case, similarly to previously described front three-image screens (1) and (2), the display areas R1, R3 and R2 are combined onto a single screen so as to obtain the front three-image screen (2).

The feature extracting unit 114a applies a well-known edge detection processing to the display areas exsected from the camera images by the display area setting unit 111a and extracts an outline of a feature existing on the surface of the ground, e.g., a white line indicating the shoulder of the road, a white line serving as a boundary separating the road from a walkway (e.g., a crosswalk), or a curb between the road and a sidewalk. The feature extracting unit 114a then extracts the intersection points between the extracted outline and the adjacent image perimeter h of the set display areas and recognizes the intersection points as “feature ends.”

When the extracted outline of the white line or the like and the adjacent image perimeter h do not intersect directly, the intersection point between the adjacent image perimeter h and an extension line of the extracted outline toward the adjacent image perimeter h is established as the feature end X.

The operation of this embodiment will now be described using the front three-image screen (1) shown in FIG. 19D as an example. A white line Wa indicating the shoulder of the road is captured in the images of the left front end lateral camera, the front lower camera, and the right front end lateral camera. A feature end X (XaL) is obtained on the adjacent image perimeter h shown in FIG. 19A, a feature end X (XaR) is obtained on the adjacent image perimeter h shown in FIG. 19B, and feature ends X (XaF, XbF) are obtained on the adjacent image perimeter h shown in FIG. 19C. When a feature end(s) X is obtained, the feature extracting unit 114a sends the control unit 113a information describing which camera photographed the image in which the feature end X was obtained, the position coordinates of the outline, and the position coordinates of the feature end X.

The fixed photographing direction of the left front end lateral camera 108a, the right front end lateral camera 108c, and the front lower camera 108b, the mounting positions of all three cameras, and data describing the focal lengths of the cameras are stored in the controller 113a in advance, and the controller 113a can calculate the actual position of a feature, e.g., a white line, extracted from the display areas of the camera images with respect to a front section reference position of the vehicle 131′. If the calculated position of the white line has the same distance from the front section reference position in the case of each camera image, the controller 113a determines that the outlines extracted from the display areas of the camera images correspond to the same white line and issues a command to the image combining unit 112a instructing it to adjust the positions of the images on the three-image screen such that the feature ends X move closer together. Based on the position adjustment command from the controller 113a, the image combining unit 112a adjusts the horizontal position of the display area R2 by reducing or enlarging the horizontal dimension thereof such that feature end X (XaL) on the adjacent image perimeter h of the display area R1 draws closer to the corresponding feature end X (XaF) on the adjacent image perimeter h of the display area R2 and such that the feature end X (XbR) on the adjacent image perimeter h of the display area R3 draws closer to the corresponding feature end X (XbF) on the adjacent image perimeter h of the display area R2. A prescribed limit value is set for the magnification to which the display area can be reduced so that the display area is not reduced to a size that is too small.

In FIG. 19D, the feature end XaF of the display area R2 has been drawn closer to the feature end XaL of the display area R1 and the feature end XbF of the display area R2 has been drawn closer to the feature end XbR of the display area R3 by reducing the horizontal dimension of the display area R2. FIG. 19E shows the tentative arrangement of the front three-image screen (3) before the position adjustment. In this state, the position of the display area R2 has not been adjusted and the feature end XaF of the display area R2 is greatly out of place in the horizontal direction with respect to the feature end XaL of the display area R1 and the feature end XbF of the display area R2 is greatly out of place in the horizontal direction with respect to the feature end XbR of the display area R3. As a result of reducing the horizontal dimension of the display area R2 so as to shift the positions in the left and right as shown in FIG. 19D, the display seems more natural because the white lines appear more like they are connected from the front lower camera image to the left and right front end camera images.

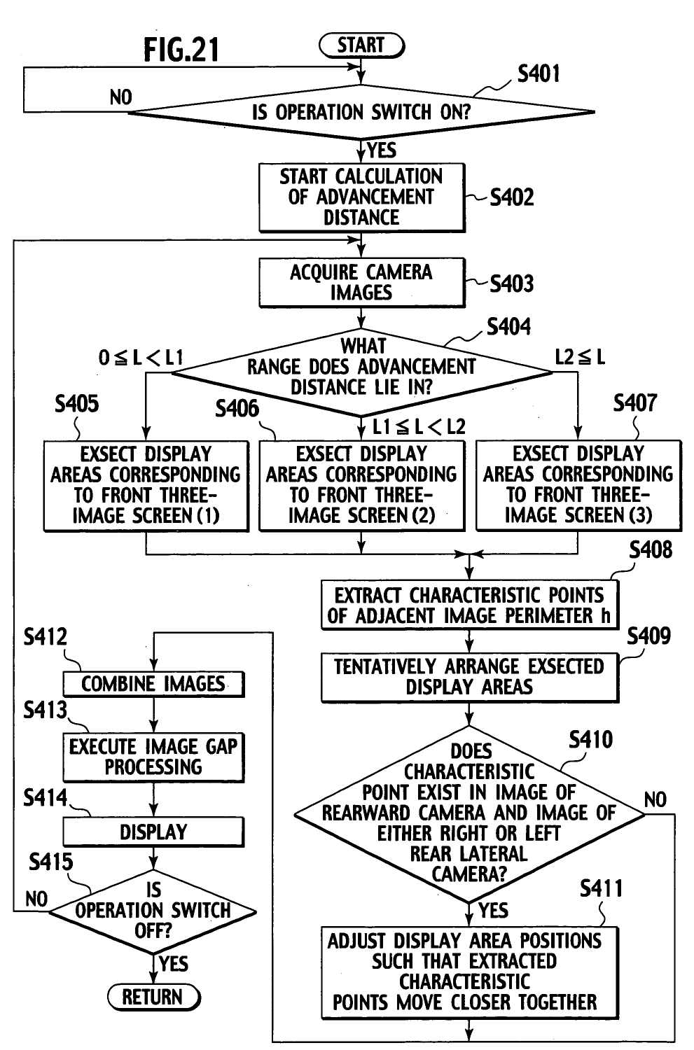

The flow of the image display switching control executed by this embodiment will now be described. FIG. 21 is a flowchart illustrating the overall flow of the steps executed in order to control the switching of the image display. When the ignition key (omitted from figures) is turned on, the vehicle surroundings monitoring system enters a waiting mode. The control routine shown in the flowchart is processed as a program executed by the controller 113a, the display area setting unit 11a, the image combining unit 112a, and the feature extracting unit 114a.

In step S401, the controller 113a checks if the operation switch 106′ is on. If the operation switch 106′ is on, the controller 113a proceeds to step S402. If not, it repeats step S402. In step S402, the vehicle surroundings monitoring system starts operating and the controller 113a starts counting the pulse signals from the wheel speed sensors 109. The controller 113a begins calculating the forward distance the vehicle 131 has moved since operation started, i.e., the advancement distance L, based on the total number of pulses counted. After step S402, control proceeds to step S403. In step S403, the display area setting unit 111a acquires the camera images photographed by the left front end lateral camera 108a, the front lower camera 108b, and the right front lateral camera 108c.

In step S404, the controller 113a checks the advancement distance L. If the advancement distance L is equal to or larger than 0 and less than the prescribed distance L1, the controller 113a proceeds to step S405 and sets the display regions to be exsected for displaying the front three-image screen (1). The controller 113a then sends a command to the display area setting unit 111a instructing it to exsect the display areas and a command to the image combining unit 112a instructing which arrangement to use. The display area setting unit 111a receives the command, exsects the specified display areas R1, R3, R2 (e.g., the display areas R1, R3, R2 indicated with broken-line frames in FIGS. 19A to 19C) from the camera images, and sends the exsected display areas to the image combining unit 112a and the feature extracting unit 114a.

If the advancement distance L is equal to or larger than the prescribed distance L1 and less than the prescribed distance L2, the controller 113a proceeds to step S406 and sets the display regions to be exsected for displaying the front three-image screen (2). The controller 113a then sends a command to the display area setting unit 111a instructing it to exsect the display areas and a command to the image combining unit 112a instructing which arrangement to use. The display area setting unit 111a receives the command, exsects the specified display areas R1, R3, R2, and sends the extracted display areas to the image combining unit 112a and the feature extracting unit 114a.

If the advancement distance L is equal to or larger than the prescribed distance L2, the controller 113a proceeds to step S407 and sets the display regions to be exsected for displaying the front three-image screen (3). The controller 113a then sends a command to the display area setting unit 111a instructing it to exsect the display areas and a command to the image combining unit 112a instructing which arrangement to use. The display area setting unit 111a receives the command, exsects the specified display areas R1, R3, R2 (e.g., the display areas R1, R3, R2 indicated with broken-line frames in FIGS. 20A to 20C) from the camera images, and sends the exsected display areas to the image combining unit 112a and the feature extracting unit 114a. After steps S405, S406, S407, control proceeds to step S408. In step S408, the feature extracting unit 114a applies edge processing to the display areas extracted from the camera images in step S405, S406, or S407 and extracts feature ends X (feature alignment points). More specifically, it detects the outline of a white line indicating, for example, the shoulder of the road and extracts feature ends X (feature alignment points), which are intersection points between the outline and the adjacent image perimeter h or between an extension line of the outline toward the adjacent image perimeter h and the adjacent image perimeter h. The feature extracting unit 114a sends information indicating the presence or absence of feature ends X and the position coordinates of the feature ends X (if present) to the controller 113a. In step S409, the image combining unit 112a tentatively arranges the display regions exsected from the camera images on a single screen. In step S410, the controller 113a checks if the extracted feature ends X (feature alignment points) exist in the display area R2 and the display area R1 or in the display area R2 and the display area R3 and if the extracted features ends belong to the same outline. If a feature end X (feature alignment point) belonging to same outline as the outline extracted from the display area R2 is determined to exist in the display area R1 or R3, control proceeds to step S411. If not, control proceeds to step S412. In step S411, the image combining unit 112a adjusts (reduces) the horizontal dimension of the display area R2 exsected from the front lower camera image so that the extracted feature ends X (feature alignment points) of the adjacent images draw closer together. After step S411, control proceeds to step S412.

In step S412, the image combining unit 112a combines the display areas arranged in step S409 or S411 onto a single screen. Then, in step S413, gap processing is executed to blacken in the gaps between the pasted images. In step S414, the display 103 presents the combined image to the driver. In step S415, the controller 113a checks if the operation switch 106′ is off. If the operation switch 106′ is not off, the controller 113a returns to step S403 and repeats the front three-image display control in accordance with the advancement distance L. If the operation switch 106′ is off, the controller 113a stops the vehicle surroundings monitoring function and returns to step S401.

Steps S404 to S414 serve to automatically change the display areas of the camera images used in the front three-image screens in accordance with the changes in the steering state of the vehicle. For example, when the vehicle moves from a stage of being at the entrance to an intersection having poor visibility to a stage of advancing to the middle of the intersection, these steps serve to change the display state in the manner explained regarding FIGS. 19A to 19E and 20A to 20D. More specifically, in the stage of being at the entrance to an intersection, the vehicle 131′ stops temporarily and there is a need for a camera image having depth in the left and right directions in order to see vehicles and pedestrians entering the intersection from the left and right. Conversely, the camera image obtained from the front lower camera need only the area in front of the vehicle 131′ so as not to overlook pedestrians existing directly in front of the vehicle 131′. In the example shown in FIG. 19D, the display areas are automatically set such that display areas of camera image having depth in the left to right directions exsected from the left and right front end lateral cameras 108a, 108c display larger, and the display area of the camera image exsected from the front lower camera 108b displays smaller. In the stage of advancing into the middle of the intersection, initial need is for the display area extracted from the front lower camera image to have as much depth as possible to enable the driver to check for obstacles existing anywhere in the entire intersection in front of the vehicle 131′. A secondary need is to enable the driver to be aware of the surrounding situation as he or she passes through the intersection, i.e., to recognize vehicles that might be approaching the intersection from the left or right. Thus, as shown in FIG. 20D, the display area exsected from the camera image of the front lower camera 108b is automatically set to have a large vertical dimension so as to display more depth in the forward direction and the display areas exsected from the camera images of the left and right front end lateral cameras 108a, 108c are automatically set to have a small vertical dimension so as to display the distant portions of the respective images. Step S402 of the flowchart can also be realized with an advancement distance detecting unit in accordance with the present invention, steps S404 to S407 can be realized with an image display area setting unit in accordance with the present invention, and step S408 can be realized with a feature extracting unit in accordance with the present invention.

With the embodiment just described, the area to the left and right sides of the of the front end of the vehicle and the low area in front of the vehicle can be monitored easily when the vehicle is entering an intersection with poor visibility or entering a road with a substantial amount of traffic from an alleyway with poor visibility because camera images photographing the leftward, rightward, and forward directions of the vehicle are combined onto a single screen in the form of the front three-image screen (1), (2), or (3). The arrangement of the images forming the front three-image screens on the display 103 is maintained irregardless of the advancement distance L, the relationship between the images is consistent and easy for the driver to understand even when the display pattern is switched among the front three-image screens (1), (2), (3). Furthermore, when the outlines of the white lines or other features contained in the display areas exsected from the camera images are determined to correspond to the same features, the positions of the display areas are adjusted (at the stage when the display areas are combined onto a single screen) such that the feature alignment points of the outlines at the adjacent image perimeters h of the display areas move closer together. As a result, the combined image screen allows the driver to monitor the leftward, rightward, and forward directions simultaneously and can be easily understood by the driver without imparting a feeling of unnaturalness.

Although the first and second embodiments are configured to switch among three different two-image screens (i.e., the two-image screens (1), (2), and (3)) or three different three-image screens (i.e., the three-image screens (1), (2), (3)) in a step-like manner based on the range in which the steering angle θ lies when the vehicle surroundings monitoring system is in Auto mode, it is also acceptable to configure the vehicle surroundings monitoring system such that the display areas are changed in a continuous manner. Also, although the left and right rearward lateral cameras 102a, 102c are installed on the door mirrors 132L, 132R in the first and second embodiments, the invention is not limited to such a configuration. It is also acceptable to install the left and right rearward lateral cameras 102a, 102c on side panels of a front section of the vehicle body, on side panels of a rear portion of the vehicle body, or on the left and right ends of a rear portion of the vehicle body. Although the third embodiment is configured to switch among three different front three-image screens (i.e., the front three-image screens (1), (2), (3)) in a step-like manner based on the range in which the advancement distance L lies when the vehicle surroundings monitoring system is in Auto mode, it is also acceptable to configure the vehicle surroundings monitoring system such that the display areas are changed in a continuous manner Furthermore, similarly to the third embodiment which uses left and right front end cameras 108a, 108c and a front lower camera 108b provided on a front section of a vehicle 131′ to monitor in the forward direction, it is also possible to configure a rearward monitoring system that uses left and right rear end lateral cameras and a rear lower camera provided on a rear section of a vehicle to monitor in the rearward direction when the vehicle is backing into a parking space or into a public road from a private road. In such a case, the rear lower camera would correspond to the first camera of the present invention and the left and right rear end lateral cameras would correspond to the seventh and eighth cameras of the present invention.

The entire contents of Japanese patent application P2004-28239 filed Feb. 4, 2004 is hereby incorporated by reference.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A vehicle surroundings monitoring system, comprising:
a plurality of cameras configured to photograph regions surrounding a vehicle;
a surroundings monitoring control unit configured to determine areas of the images photographed by the cameras to be displayed based on the steering state of the vehicle or an input from a driver and to output image data that combines the images contained in the determined display areas in such a manner that items captured in the displayed images are arranged in positional relationships observed by a driver; and
a display configured to display the image data outputted from the surroundings monitoring control unit, wherein
the surroundings monitoring control unit is further configured such that it can control the proportion of the display that is occupied by each image displayed on the display.

2. The vehicle surroundings monitoring system as claimed in claim 1, wherein the surroundings monitoring control unit comprises:
a control unit configured to determine areas to be exsected from the camera images based on the steering state of the vehicle or an input from a driver and, based on the steering state of the vehicle or an input, determine an arrangement of the exsected images in positional relationships between items captured in the exsected images to be the positional relationships observed by a driver;
a display area setting unit configured to receive information from the control unit specifying the areas to be exsected from the images photographed by the cameras, exsect the specified areas from the images, and output image data describing the exsected images; and
an image combining unit configured to receive information specifying the arrangement of the exsected images and image data describing the exsected images from the control unit, arrange the exsected images in such a manner that the positional relationships between items captured in the exsected images is the positional relationships observed by a driver, and output image data describing the exsected images and arrangement of the exsected images to the display.

3. The vehicle surroundings monitoring system as claimed in claim 1, further comprising:
a steering state detecting unit configured to detect the steering state of the vehicle and output vehicle steering state information describing the steering state of the vehicle; and
an image selecting unit configured to select which of the photographed images to display on the display based on the vehicle steering state information and output image selection information indicating which images have been selected, wherein
the surroundings monitoring control unit comprises:
a control unit configured to determine areas to be exsected from the camera images based on the vehicle steering state information and the image selection information and, based on the vehicle steering state information, determine an arrangement of the exsected images that causes the positional relationships between items captured in the exsected images to be the positional relationships observed by a driver;
a display area setting unit configured to receive information from the control unit specifying the areas to be exsected from the images photographed by the cameras, exsect the specified areas from the images, and output image data describing the exsected images; and
an image combining unit configured to receive information specifying the arrangement of the exsected images and image data describing the exsected images from the control unit, arrange the exsected images in such a manner that the positional relationships between items captured in the exsected images are to be the positional relationships observed by a driver, and output image data to the display.

4. The vehicle surroundings monitoring system as claimed in claim 3, wherein
the steering state detecting unit is configured to detect if the gearshift of the vehicle is in a reverse gear position and detect the steering angle; and
the control unit is configured to determine the areas to be exsected from the camera images based on the steering angle when the vehicle is in a reverse gear.

5. The vehicle surroundings monitoring system as claimed in claim 1, wherein the plurality of cameras comprises:
a first camera mounted to a rear section of the vehicle and is arranged and configured to photograph in a rearward direction;
a second camera mounted to a left side section of the vehicle and is arranged and configured to photograph a region located behind the left side section of the vehicle;
a third camera mounted to a right side section of the vehicle and is arranged and configured to photograph a region located behind the right side section of the vehicle.

6. The vehicle surroundings monitoring system as claimed in claim 3, wherein
the plurality of cameras comprises:
a first camera mounted to a rear section of the vehicle and is arranged and configured to photograph in a rearward direction,
a second camera mounted to a left side section of the vehicle and is arranged and configured to photograph a region located behind the left side section of the vehicle, and
a third camera mounted to a right side section of the vehicle and is arranged and configured to photograph a region located behind the right side section of the vehicle;
the steering state detecting unit is configured to detect if the gearshift of the vehicle is in a reverse gear position and detect the steering angle; and
the image selecting unit is configured to select the camera images of the first and second cameras so as to display an image showing regions behind the left side section of the vehicle and directly behind the vehicle when the vehicle is in a reverse gear and a leftward steering state and select the camera images of the first and third cameras so as to display an image showing regions behind the right side section of the vehicle and directly behind the vehicle when the vehicle is in a reverse gear and a rightward steering state.

7. The vehicle surroundings monitoring system as claimed in claim 6, wherein the control unit determines the display areas to be exsected from the images photographed with the cameras in such a manner that the following conditions are met:
when the steering angle is leftward, the larger the leftward steering angle is, the more the display area exsected from the camera image of the second camera is expanded outward in the leftward direction and the more the display area exsected from the camera image of the first camera is narrowed from the left and right toward the center of the image in the transverse direction of the vehicle;
when the steering angle is rightward, the larger the rightward steering angle is, the more the display area exsected from the camera image of the third camera is expanded outward in the rightward direction and the more the display area exsected from the camera image of the first camera is narrowed from the left and right toward the center of the image in the transverse direction of the vehicle;
when the steering angle is leftward, the smaller the leftward steering angle is, the more the display area exsected from the camera image of the second camera is narrowed with respect to the leftward outward direction and the more the display area exsected from the camera image of the first camera is expanded to the left and right away from the center of the image in the transverse direction of the vehicle; and
when the steering angle is rightward, the smaller the rightward steering angle is, the more the display area exsected from the camera image of the third camera is narrowed with respect to the rightward outward direction and the more the display area exsected from the camera image of the first camera is expanded to the left and right away from the center of the image in the transverse direction of the vehicle.

8. The vehicle surroundings monitoring system as claimed in claim 3, wherein
the plurality of cameras comprises:
a first camera mounted to a rear section of the vehicle and is arranged and configured to photograph in a rearward direction,
a second camera mounted to a left side section of the vehicle and is arranged and configured to photograph a region located behind the left side section of the vehicle, and
a third camera mounted to a right side section of the vehicle and is arranged and configured to photograph a region located behind the left side section of the vehicle;
the steering state detecting unit is configured to detect if the gearshift of the vehicle is in a reverse gear position and to detect the steering angle; and
the control unit is configured such that, when the vehicle is in reverse, it determines the display areas to be exsected from the images photographed with the cameras in such a manner that the following conditions are met:
the larger the leftward or rightward steering angle is, the more the display area exsected from the camera image of the second camera is expanded toward a leftward near region of the field of view, the more the display area exsected from the camera image of the third camera is expanded in the rightward near region of the field of view, and the more the display area exsected from the camera image of the first camera is narrowed to a region closer to the rear section of the vehicle, and
the smaller the leftward or rightward steering angle is, the more the display area exsected from the camera image of the second camera is narrowed to a leftward distant region of the field of view, the more the display area exsected from the camera image of the third camera is narrowed to a rightward distant region of the field of view, and the more the display area exsected from the camera image of the first camera is expanded toward a distant region of the field of view from the rear section of the vehicle.

9. The vehicle surroundings monitoring system as claimed in claim 2, further comprising:
a steering state detecting unit configured to detect the steering state of the vehicle and output vehicle steering state information describing the steering state of the vehicle;
an image count selector switch configured to receive input from a driver specifying the number of images to be displayed on the display;
an display area selector switch configured to receive input from a driver specifying the display areas to be displayed on the display; and
an image selecting unit configured to select camera images photographed by the cameras based on the steering state information, the input to the image count selection switch, and the input to the display area selector switch and output image selection information specifying which images were selected,
wherein the surroundings monitoring control unit comprises:
a control unit configured to determine areas to be exsected from the camera images based on the vehicle steering state information and the image selection information and, based on the vehicle steering state information, determine an arrangement of the exsected images in positional relationships between items captured in the exsected images to be the positional relationships observed by a driver;
a display area setting unit configured to receive information from the control unit specifying the areas to be exsected from the images photographed by the cameras, exsect the specified areas from the images, and output image data describing the exsected images; and
an image combining unit configured to receive information specifying the arrangement of the exsected images and image data describing the exsected images from the control unit, arrange the exsected images in such a manner that the positional relationships between items captured in the exsected images are arranged in positional relationships observed by a driver, and output image data describing the exsected images and the arrangement of the exsected images to the display.

10. The vehicle surroundings monitoring system as claimed in claim 2, further comprising:
an operation switch that can be operated by a driver; and
an advancement distance detecting unit configured to calculate the distance the vehicle advances after the operation switch is turned on,
wherein the plurality of cameras comprises:
a first camera mounted to a front section of the vehicle in a transversely central position with respect to the transverse direction of the vehicle and is arranged and configured to photograph in a forward and downward direction,
a second camera mounted to a front section of the vehicle and is arranged and configured to photograph in a direction leftward of the vehicle, and
a third camera mounted to a front section of the vehicle and is arranged and configured to photograph in a direction rightward of the vehicle; and
the control unit determines the display areas to be exsected from the images photographed with the cameras in such a manner that the following conditions are met:
when the advancement distance is small, the display area exsected from the camera image of the second camera is expanded from a leftward distant region of the field of view toward a nearer region of the field of view, the display area exsected from the camera image of the third camera is expanded from a rightward distant region of the field of view toward a nearer region of the field of view, and the display area exsected from the camera image of the first camera is narrowed to a region closer to the front section of the vehicle;
when the advancement distance is large, the display area exsected from the camera image of the second camera is narrowed to a leftward distant region of the field of view, the display area exsected from the camera image of the third camera is narrowed to a rightward distant region of the field of view, and the display area exsected from the camera image of the first camera is expanded toward a distant region of the field of view from the front section of the vehicle.

11. The vehicle surroundings monitoring system as claimed in claim 2, further comprising:
an operation switch that can be operated by a driver; and
an advancement distance detecting unit configured to calculate the distance the vehicle advances after the operation switch is turned on,
wherein the plurality of cameras comprises:
a first camera mounted to a rear section of the vehicle in a transversely central position with respect to the transverse direction of the vehicle and is arranged and configured to photograph in a rearward and downward direction,
a second camera mounted to a rear section of the vehicle and is arranged and configured to photograph in a direction leftward of the vehicle, and
a third camera mounted to a rear section of the vehicle and is arranged and configured to photograph in a direction rightward of the vehicle;
the control unit determines the display areas to be exsected from the images photographed with the cameras in such a manner that the following conditions are met:
when the advancement distance is small, the display area exsected from the camera image of the second camera is expanded from a leftward distant region of the field of view toward a nearer region of the field of view, the display area exsected from the camera image of the third camera is expanded from a rightward distant region of the field of view toward a nearer region of the field of view, and the display area exsected from the camera image of the first camera is narrowed to a region closer to the rear section of the vehicle;
when the advancement distance is large, the display area exsected from the camera image of the second camera is narrowed to a leftward distant region of the field of view, the display area exsected from the camera image of the third camera is narrowed to a rightward distant region of the field of view, and the display area exsected from the camera image of the first camera is expanded toward a distant region of the field of view from the rear section of the vehicle.

12. The vehicle surroundings monitoring system as claimed in claim 2, further comprising:
a feature extracting unit configured to extract feature alignment points existing on the ground in the images exsected by the display area setting unit,
wherein the image combining unit arranges the exsected images in such a manner that the feature alignment points extracted from the display areas of the camera images by the feature extracting unit are drawn closer together.

13. The vehicle surroundings monitoring system as claimed in claim 6, further comprising:
a photographing direction setting unit configured to set the photographing directions of the second camera and the third camera based on the steering angle detected steering state detecting unit; and
actuators configured to change the photographing directions of the second camera and third camera based on the photographing directions of the second camera and third camera set by the photographing direction setting unit.

14. The vehicle surroundings monitoring system as claimed in claim 9, further comprising:
a photographing direction setting unit configured to set the photographing directions of the second camera and the third camera based on the input to the display area selector switch; and
an actuator(s) configured to change the photographing directions of the second camera and third camera based on the photographing directions of the second camera and third camera set by the photographing direction setting unit.

15. A vehicle with a surroundings monitoring system, comprising:
a plurality of cameras configured to photograph regions surrounding a vehicle;
a surroundings monitoring control unit configured to determine areas of the images photographed by the cameras to be displayed based on the steering state of the vehicle or an input from a driver and to output image data that combines the images contained in the determined display areas in such a manner that items captured in the displayed images are arranged in positional relationships observed by a driver; and
a display configured to display the image data outputted from the surroundings monitoring control unit, wherein
the surroundings monitoring control unit is further configured such that it can control the proportion of the display that is occupied by each image displayed on the display.

16. The vehicle as claimed in claim 15, wherein the surroundings monitoring control unit comprises:
a control unit configured to determine areas to be exsected from the camera images based on the steering state of the vehicle or an input from a driver and, based on the steering state of the vehicle or an input, determine an arrangement of the exsected images in positional relationships between items captured in the exsected images to be the positional relationships observed by a driver;
a display area setting unit configured to receive information from the control unit specifying the areas to be exsected from the images photographed by the cameras, exsect the specified areas from the images, and output image data describing the exsected images; and
an image combining unit configured to receive information specifying the arrangement of the exsected images and image data describing the exsected images from the control unit, arrange the exsected images in such a manner that the positional relationships between items captured in the exsected images is the positional relationships observed by a driver, and output image data describing the exsected images and arrangement of the exsected images to the display.

17. A method of monitoring the surroundings of a vehicle, comprising:
photographing a plurality of images of regions surrounding the vehicle;
determining areas of the photographed images to be displayed on a display based on the steering state of the vehicle or an input from a driver; and
combining the images contained in the determined display areas to display in such a manner that the positional relationships between items captured in the displayed images are to be the positional relationships observed by a driver;
wherein the proportion of the display occupied by each image displayed on the display is controlled.

18. The vehicle surroundings monitoring method as claimed in claim 17, wherein
when the areas of the photographed images to be displayed on the display are determined based on the steering state of the vehicle or an input from the driver, the areas to be exsected from the photographed images are determined based on the steering state of the vehicle or an input from the driver; and
when the images contained in the determined display areas are combined and displayed in such a manner that the positional relationships between items captured in the displayed images are to be the positional relationships observed by a driver, an arrangement of the images exsected based on the steering state of the vehicle or an input from the driver is determined in which the positional relationships between items captured in the displayed images are to be the positional relationships observed by a driver and the exsected display areas are displayed in the determined arrangement.

19. The vehicle surroundings monitoring method as claimed in claim 18, further comprising:
detecting the steering state of the vehicle;
selecting photographed images to display based on the detected vehicle steering state;
wherein when the areas of the photographed images to be displayed on the display are determined based on the steering state of the vehicle or an input from the driver, the areas to be exsected from the photographed images are combined based on the detected steering state; and
when the images contained in the determined display areas are combined and to display in such a manner that the positional relationships between items captured in the displayed images are to be the positional relationships observed by a driver, the determined display areas are exsected from the selected images, an arrangement of the exsected display areas is determined in which the positional relationships between items captured in the displayed images are to be the positional relationships observed by a driver, and the exsected display areas are displayed in the determined arrangement.

20. The vehicle surroundings monitoring method as claimed in claim 18, further comprising:
detecting the steering state of the vehicle;
receiving input specifying the number of images to be displayed from the driver;
receiving input specifying the image display areas to be displayed from the driver; and
selecting images from among the plurality of photographed images based on the detected steering state, the input specifying the number of images to be displayed, and the input specifying the image display areas to be displayed,
wherein when the areas of the photographed images to be displayed on the display are determined based on the steering state of the vehicle or an input from the driver, the areas to be exsected from the photographed images are determined based on the detected steering state, the input specifying the number of images to be displayed, and the input specifying the image display areas to be displayed;
when the images contained in the determined display areas are combined and displayed in such a manner that the positional relationships between items captured in the displayed images are to be the positional relationships observed by a driver, an arrangement of the display areas in which the positional relationships between items captured in the displayed images are to be the positional relationships observed by a driver is determined based on the detected steering state, the determined display areas are exsected from the selected images, and the exsected display areas are displayed in the determined arrangement.
